(19) United States
(12) Patent Application Publication
(10) Pub. No.: US 2005/0240503 A1
(43) Pub. Date: Oct. 27, 2005

(54) Detailed trade data report

(75) Inventors: Thomas Christian Parker, Belle Mead, NJ (US); Richard Anthony Ferrera, Macungie, PA (US); Peter Frederick Kinkel, Lebanon, NJ (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Dun & Bradstreet, Inc.

(21) Appl. No.: 10/830,483

(22) Filed: Apr. 22, 2004

(51) Int. Cl. G06F 17/60

(52) U.S. Cl. 705/37

(57) ABSTRACT

A payment performance score is calculated for particular industries, payment ranges, and time periods, such as 3, 6, 9, and 12 month calculations. The score is predictive of how a company will pay a particular party. The score is based on trade experiences and is provided in a report.

### BACKGROUND OF THE INVENTION

1. Field of the Invention

The present disclosure generally relates to providing business and financial information. In particular, the present disclosure relates to detailed trade data and payment experiences.

2. Description of Related Art

Traditionally, a payment index (PAYDEX™) score, which is a credit information service that rates payment performance, was calculated for all trade experiences. The score was a weighted average of how fast or slow a company paid others. The company may have a good score, yet pay some parties on time and others late. For example, a company may pay parties with big relationships one way and those with small relationships another way.

Customer feedback indicated that they wanted more data used in the calculation; they wanted the data to be fresher, and they wanted the data to be more relevant to them in particular. The customer experience was that some customers behaved just like the score and others did not and they did not know why. There is a need for a payment performance score segmented by industry and payment ranges that is more predictive of how a company will pay a particular party.

### BRIEF SUMMARY OF THE INVENTION

The present disclosure is directed to a system and method for portfolio monitoring that meets these and other needs.

One aspect of the present disclosure is a method for providing detailed trade data. A request for a report is received. A number of scores are calculated within a number of measuring periods by taking a weighted average of at least 4 trade experiences for each score within each measuring period. The report is provided, including the scores. In some embodiments, the measuring periods are 3, 6, 9, or 12 months. A 3 month score is calculated for a 3 month manner of payment by 3 month trade experiences using a current weighted average calculation with at least 4 trade experiences. A 6 month score is calculated for a 6 month manner of payment by 6 month trade experiences using a current weighted average calculation with at least 4 trade experiences. A 9 month score is calculated for a 9 month manner of payment by 9 month trade experiences using a current weighted average calculation with at least 4 trade experiences. A 12 month score is calculated for a 12 month manner of payment by 12 month trade experiences using a current weighted average calculation with at least 4 trade experiences. In some embodiments, a largest high credit is provided. The largest high credit is the largest trade experience within the measuring period. In some embodiments, a most seen payment is provided. The most seen payment is the manner of payment that occurs most often within the measuring period.

Another aspect is a computer-readable medium, such as a compact disk (CD) having executable instructions stored thereon to perform a method for providing detailed trade data. A request for a report is received. Calculations are performed to determine 12 monthly scores by calculating each monthly score as a 3 month score. The 3 month score is calculated for a 3 month manner of payment by 3 month trade experiences using a current weighted average calculation with at least 4 trade experiences. The report is provided, including the 12 monthly scores. In some embodiments, the 3 month score uses a current month and two prior months. In some embodiments, a yearly trend is indicated.

Another aspect is a computer-readable medium having executable instructions stored thereon to perform a method for providing detailed trade data. A request for a report is received. Calculations are performed to determine at least one score for at least one industry by taking a weighted average of at least 4 trade experiences for each score within a measuring period. The report is provided, including the score. In some embodiments, the industry is identified by a standard industrial classification (SIC). In some embodiments, the measuring period is 3, 6, 9, or 12 months. In some embodiments, the number of total payments for each industry is provided. The number of total payments is the number of experiences used to calculate the score. In some embodiments, a current trend is provided. In some embodiments, the current trend is calculated in comparison to a 12 month score with a measuring period of 12 months. In some embodiments, a 3 month score is compared to the 12 month score. In some embodiments, a 6 month score is compared to the 12 month score. In some embodiments, a 9 month score is compared to the 12 month score.

Another aspect is a computer-readable medium having executable instructions stored thereon to perform a method for providing detailed trade data. A request for a report is received. Calculations are performed to determine a number of scores for a number of credit ranges by taking a weighted average of at least 4 trade experiences for each score within a measuring period. The credit ranges are based on a credit amount extended and a current payment trend profile. The report is provided, including the scores. In some embodiments, the total payments for each credit range is provided. The total payments are the number of trade experiences for the past 12 months. In some embodiments, the scores are for an industry. In some embodiments, a current trend is provided. The current trend is calculated in comparison to a 12 month score with a measuring period of 12 months. In some embodiments, a 3 month score is compared to the 12 month score. In some embodiments, a 6 month score is compared to the 12 month score. In some embodiments, a 9 month score is compared to the 12 month score.

Another aspect is a system for providing detailed trade data, including a web fabricator, at least one database system, and a component. The web fabricator fabricates a report. The report has at least one score that is calculated within a measuring period by taking a weighted average of at least 4 trade experiences within the measuring period. The database system stores data for the report and the trade experiences. The component retrieves data associated with the report from the database system, calculates the score, and forward the score and the data to the web fabricator. In some embodiments, the report is provided within five seconds of a request for the report being received by the web fabricator. In some embodiments, the report includes a yearly trend. In some embodiments, the report includes scores segmented by industry. In some embodiments, the report includes scores segmented by size of credit extended. In some embodiments, the measuring period is 3, 6, 9, or 12 months.

### BRIEF DESCRIPTION OF THE DRAWINGS

These and other features, aspects, and advantages of the present disclosure will become better understood with regard to the following description, appended claims and accompanying drawings where:

FIG. 1 is an example screenshot showing scores by time period;

FIG. 2 is an example screenshot showing a yearly trend of scores;

FIG. 3 is an example screenshot showing score by industry;

FIG. 4 is an example screenshot showing score by size of credit;

FIG. 5 is a block diagram of an example system architecture for fabricating a report;

FIG. 6 is a block diagram of an example system architecture for retrieving data for a report;

FIGS. 7A, 7B, 7C, 7D, 7E, 7F, 7G, 7H, 7I, 7J, 7K, 7L, 7M, 7N, 7O, 7P, 7Q, 7R, 7S, 7T, 7U, 7V, 7W, 7X, 7Y, 7Z, and 7AA form an example report; and

FIGS. 8A, 8B, 8C, 8D, 8E, 8F, 8G, 8H, 8I, 8J, 8K, 8L, 8M, 8N, 8O, 8P, 8Q, 8R, 8S, 8T, 8U, and 8V form another example report.

### DETAILED DESCRIPTION OF THE INVENTION

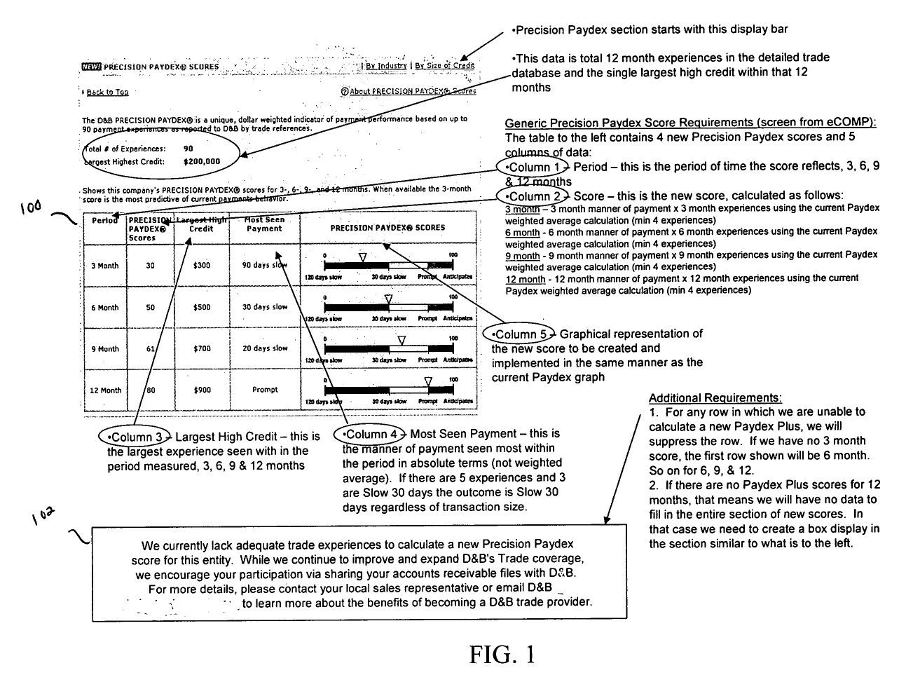

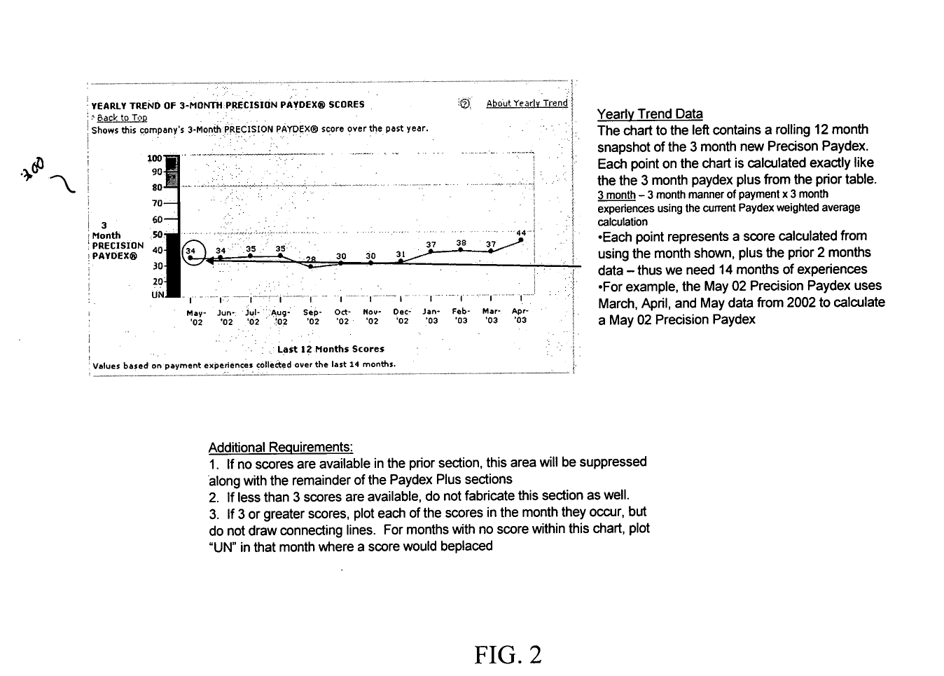

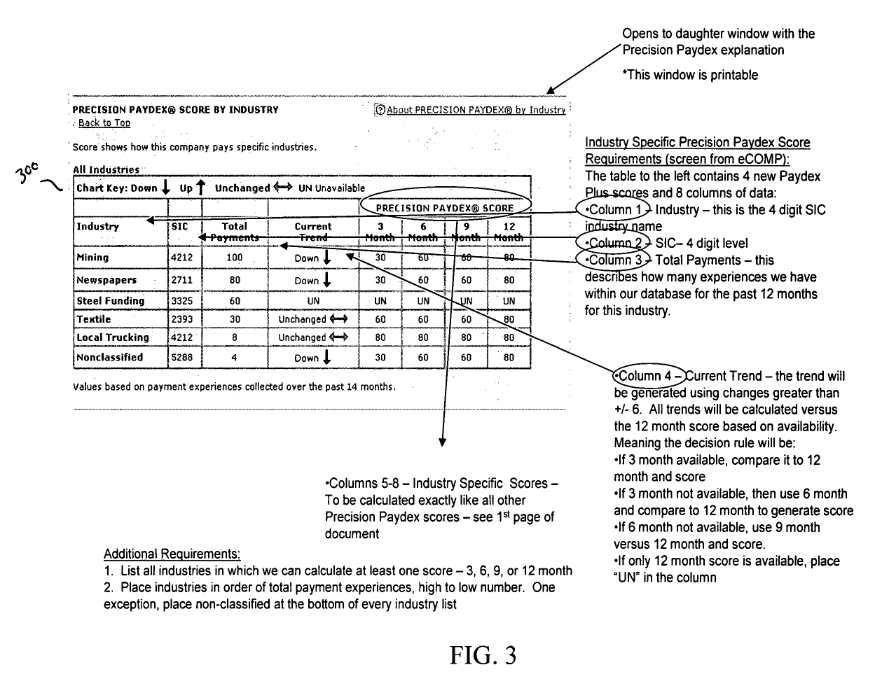

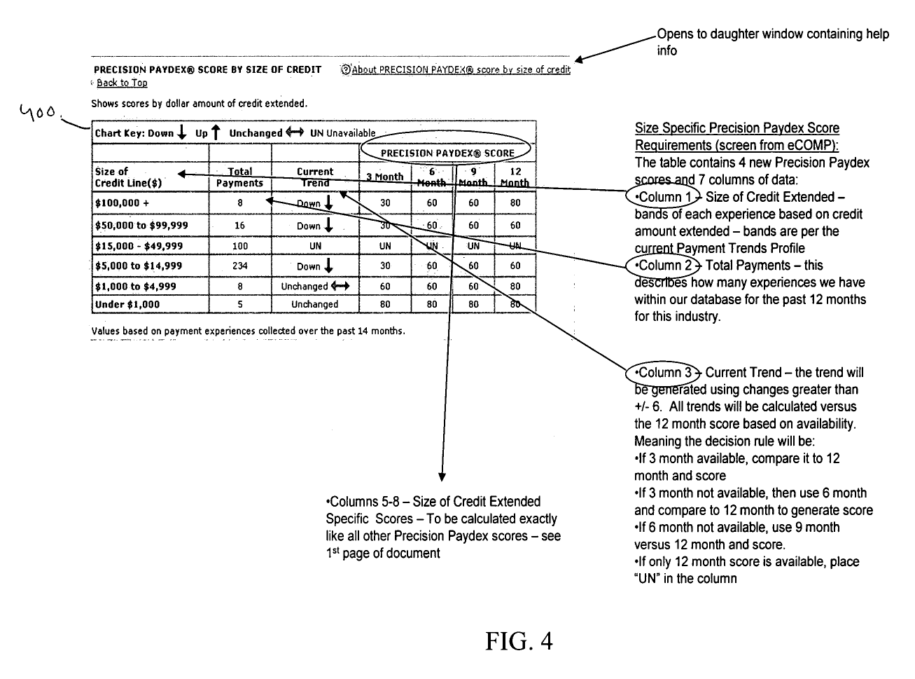

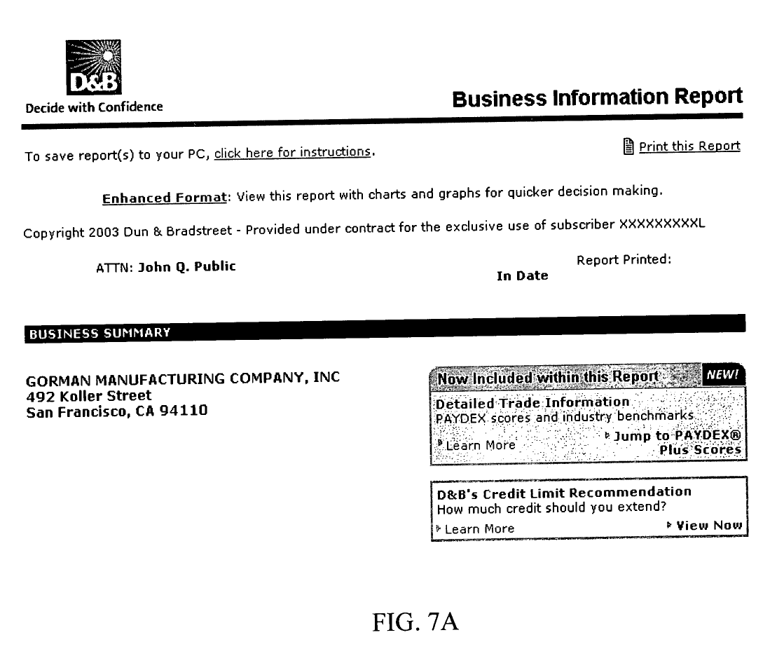

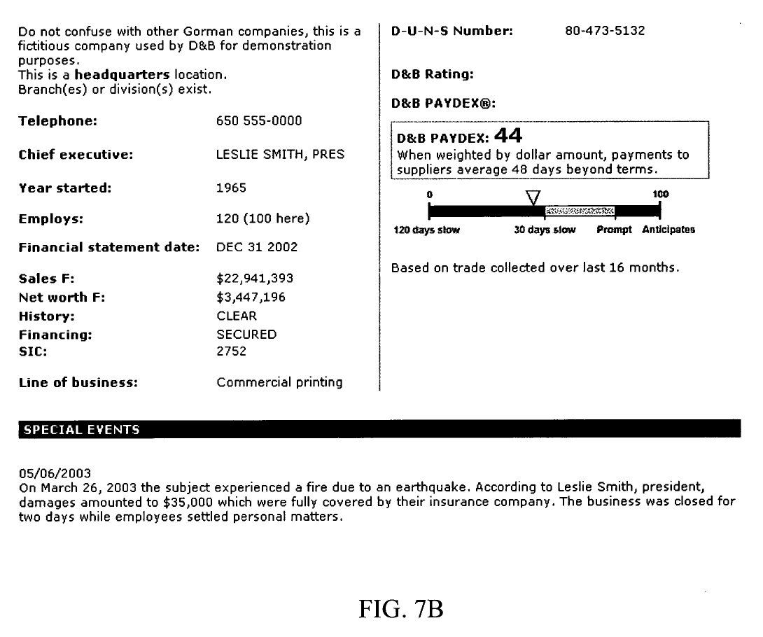

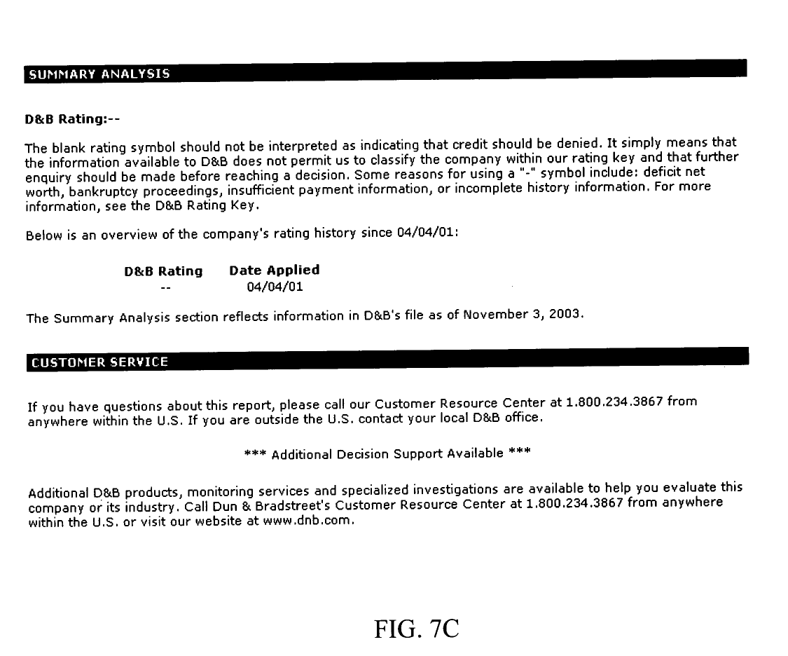

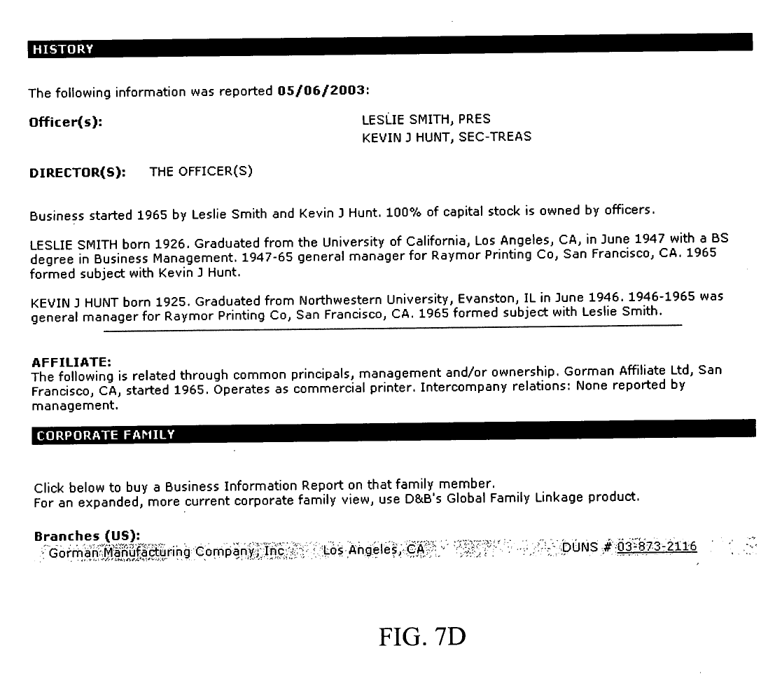

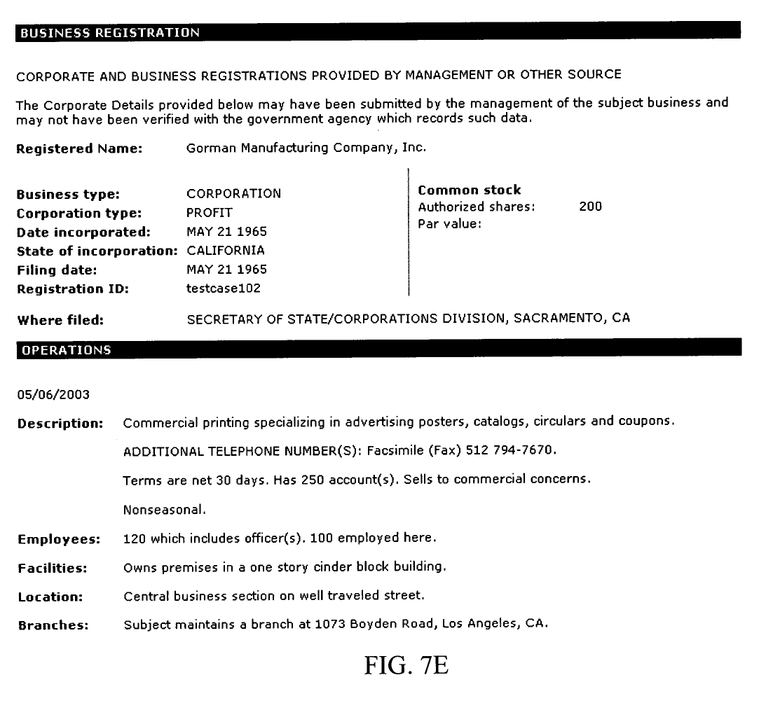

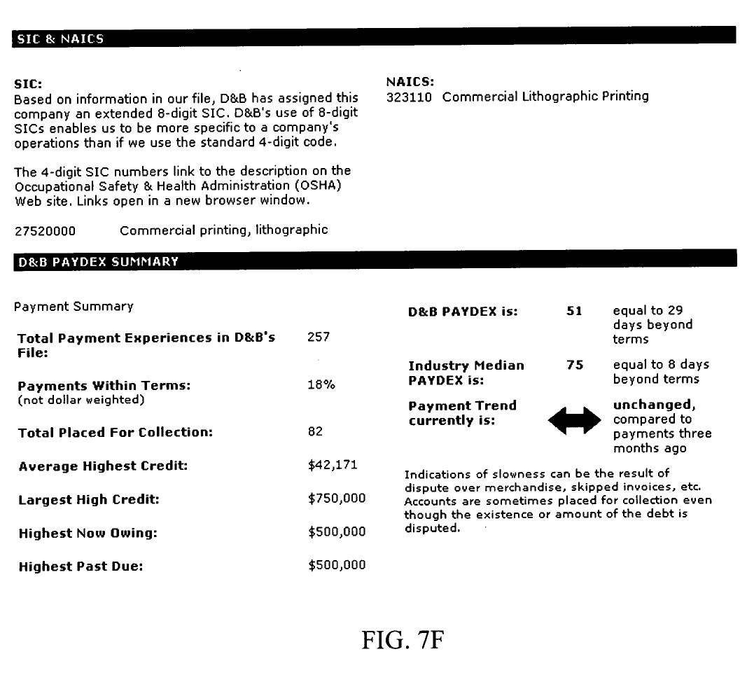

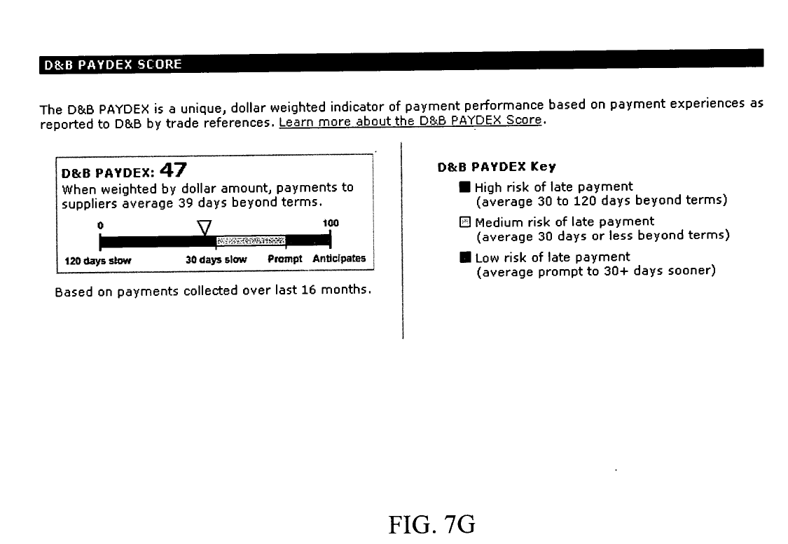

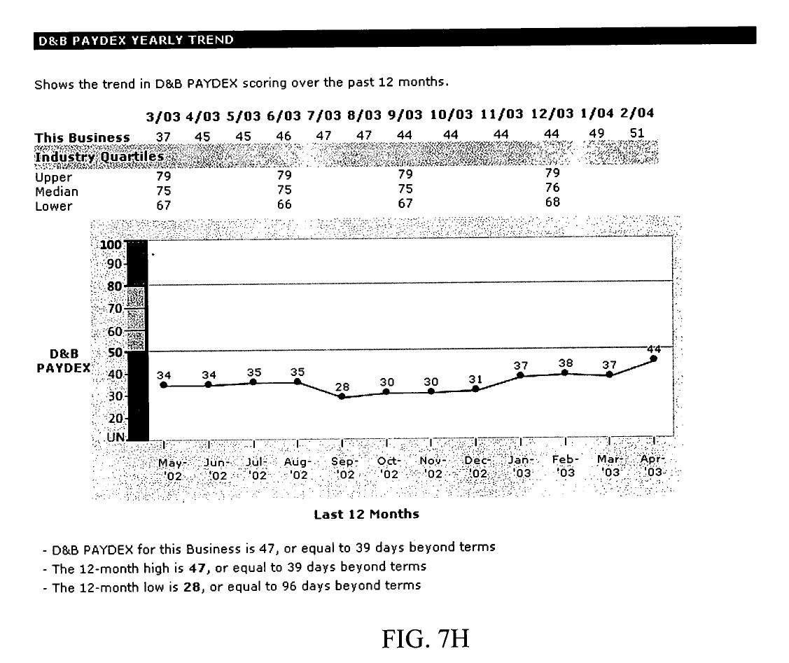

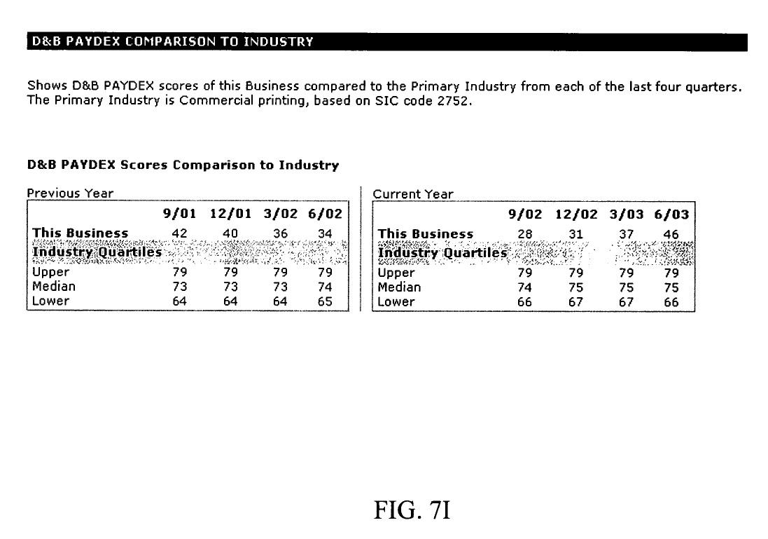

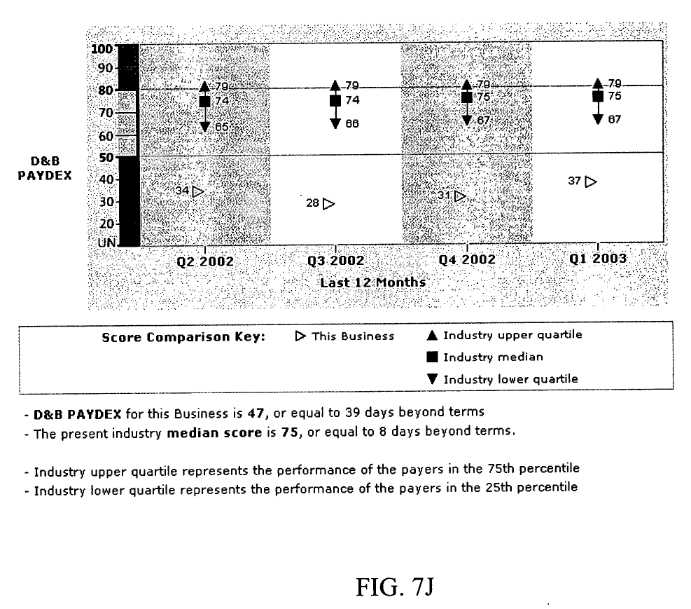

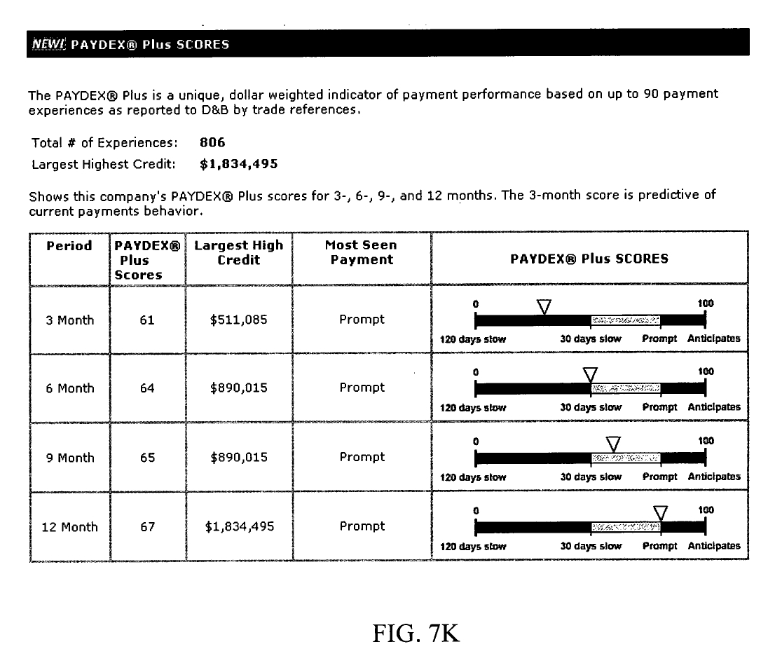

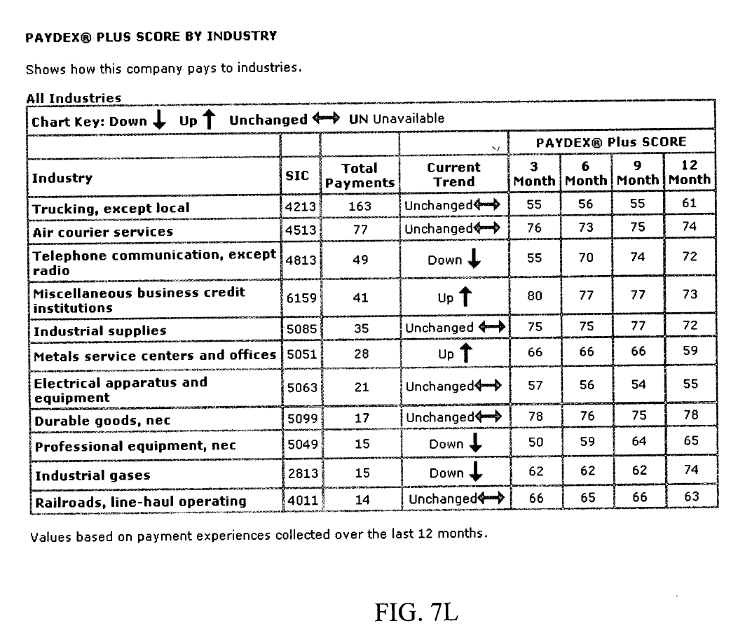

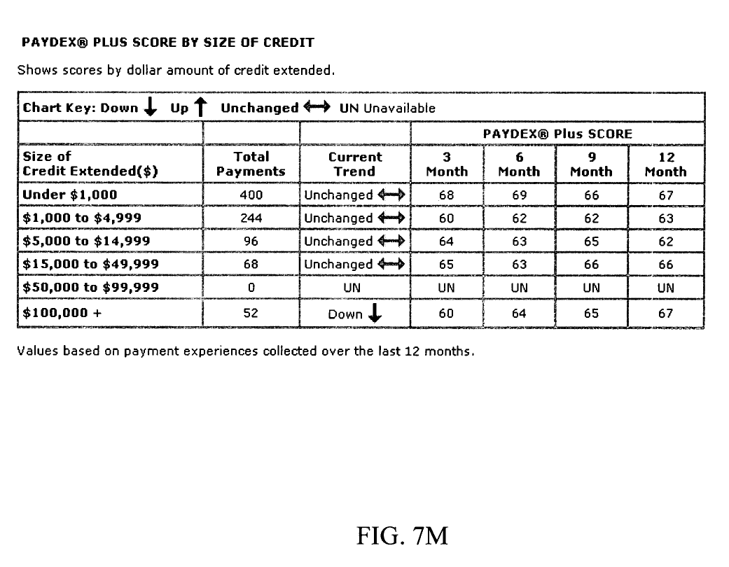

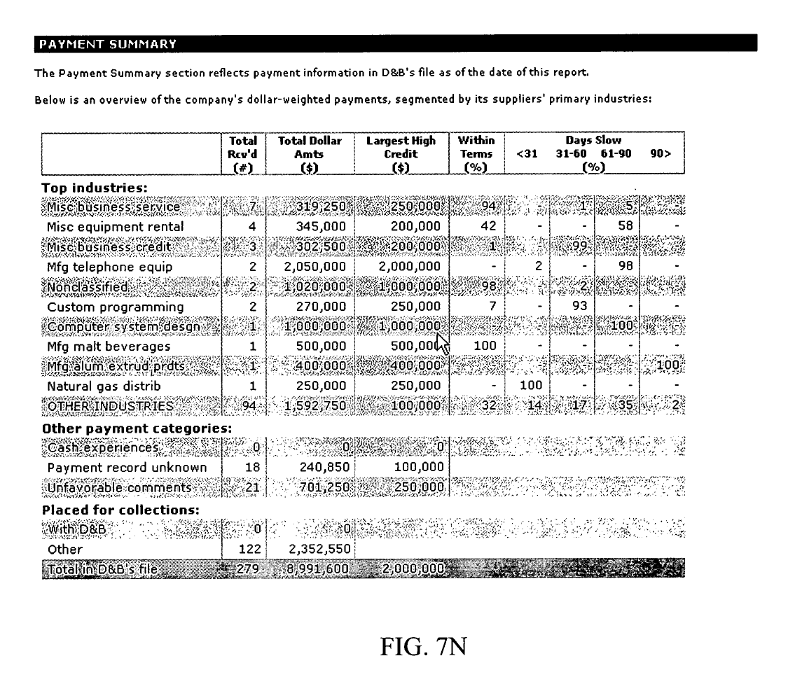

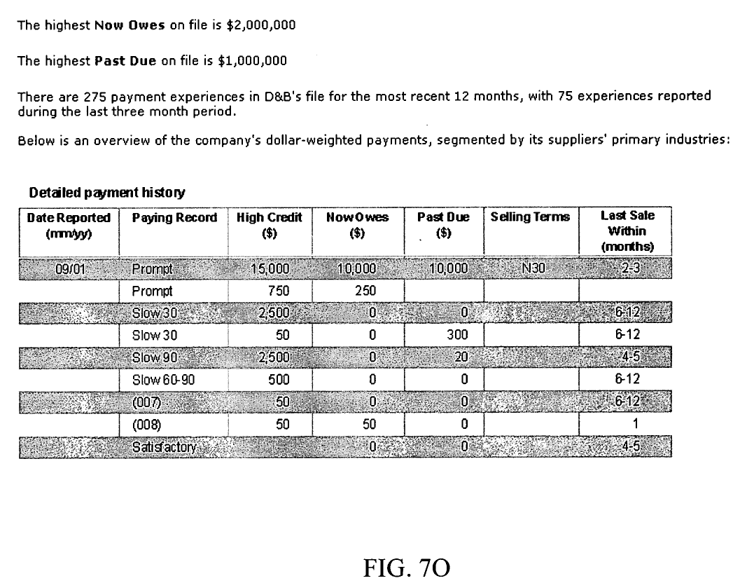

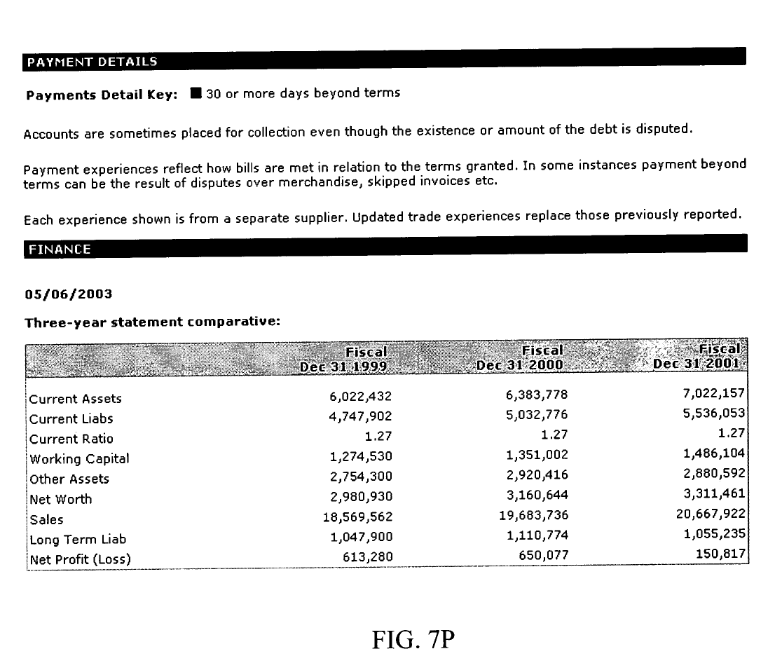

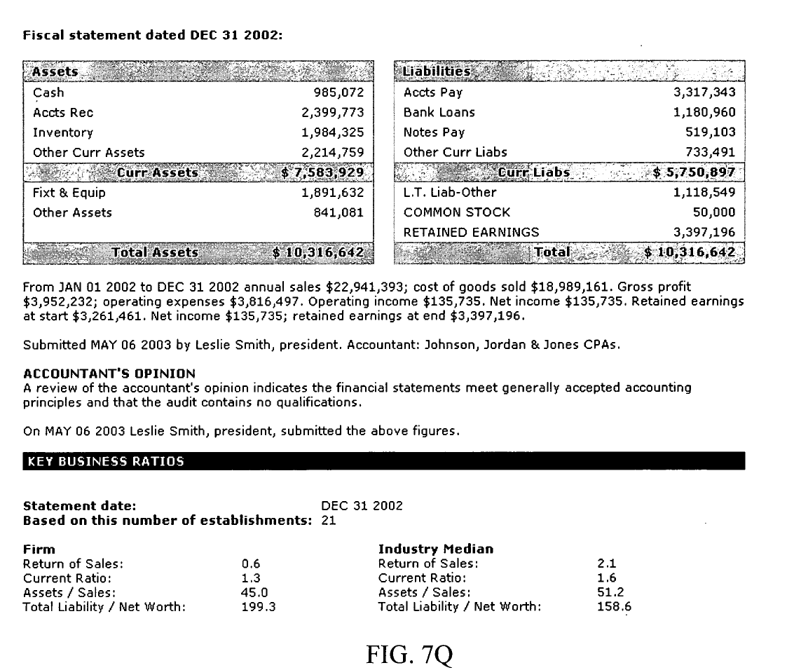

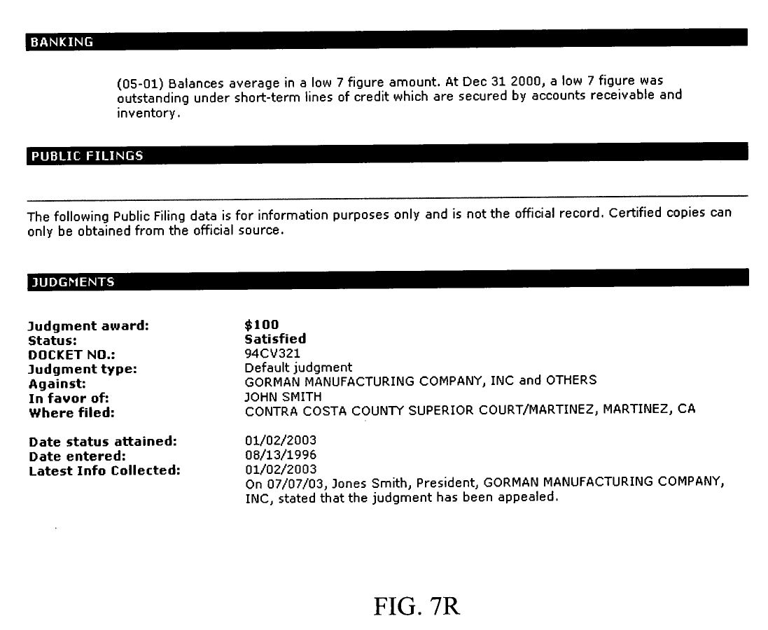

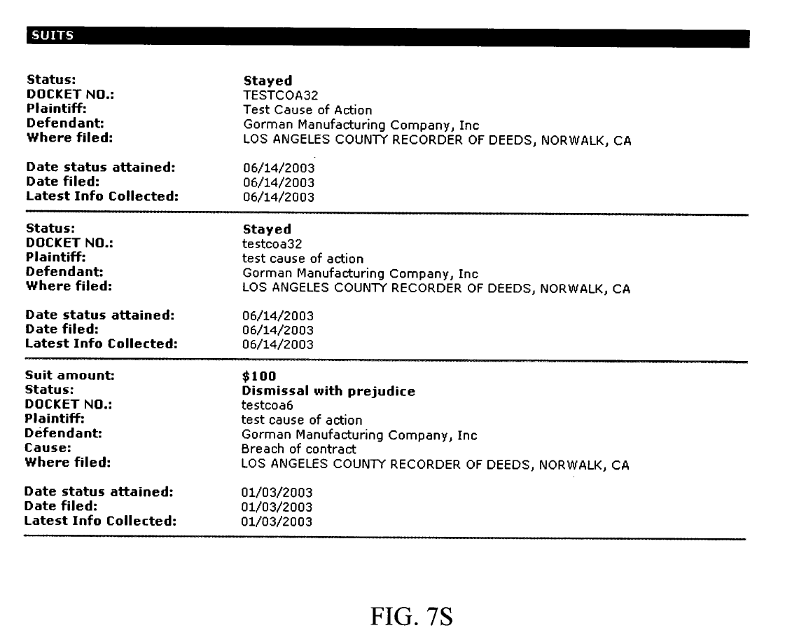

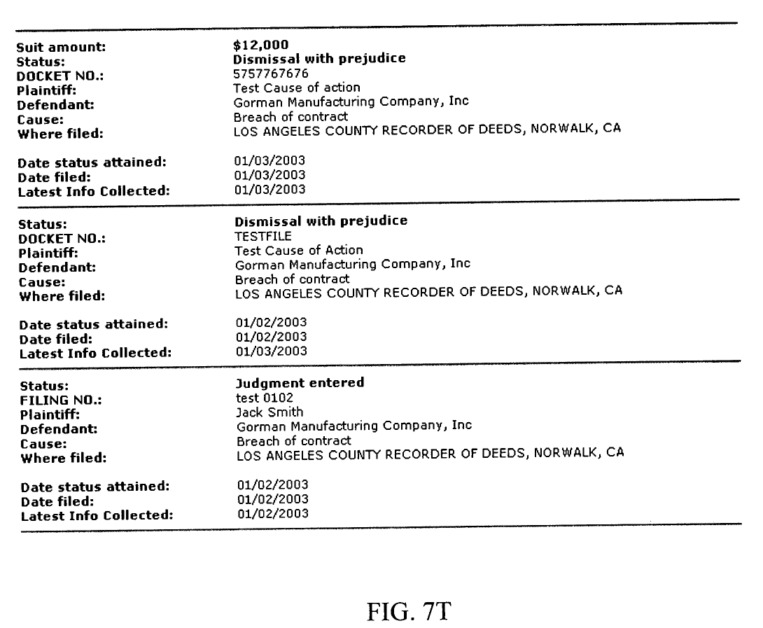

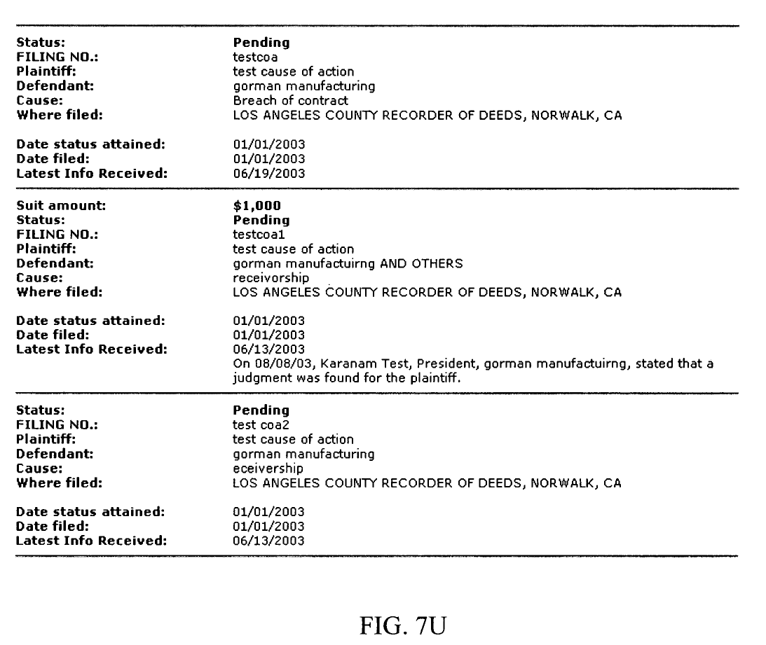

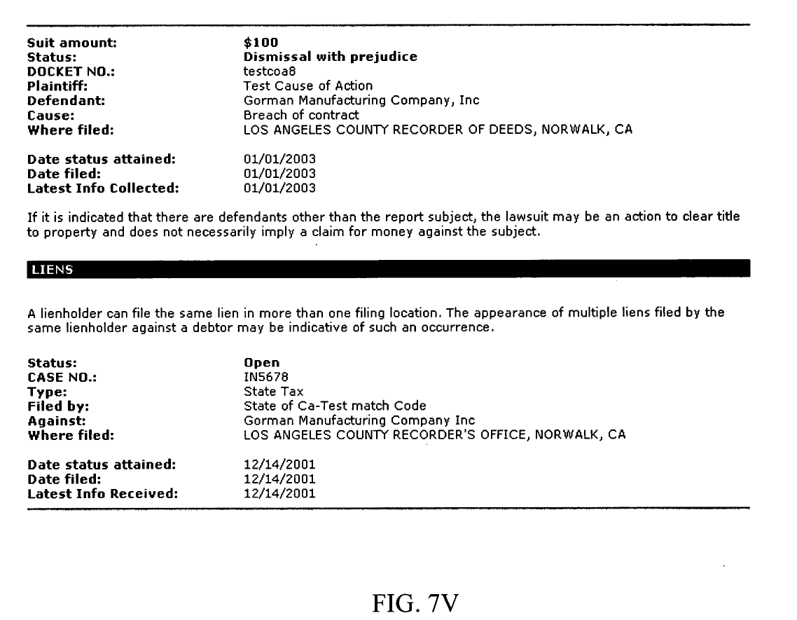

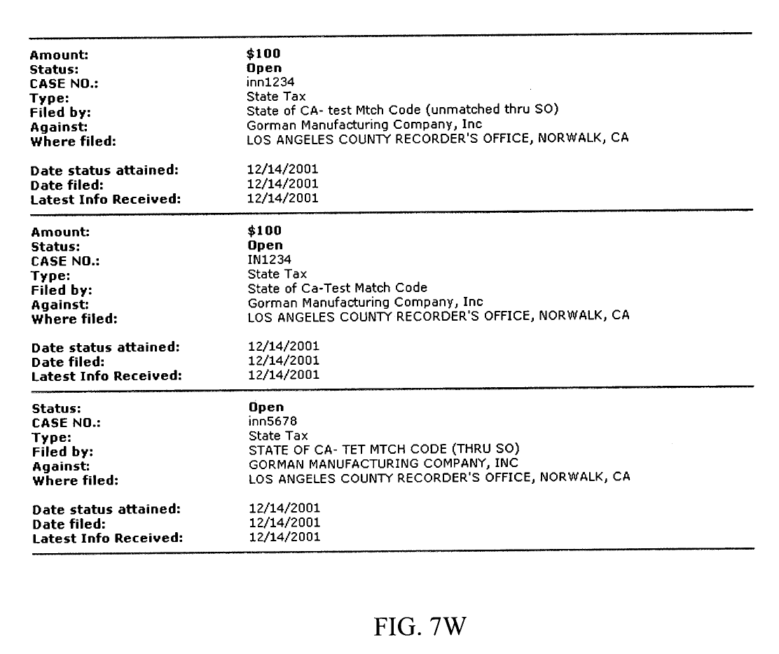

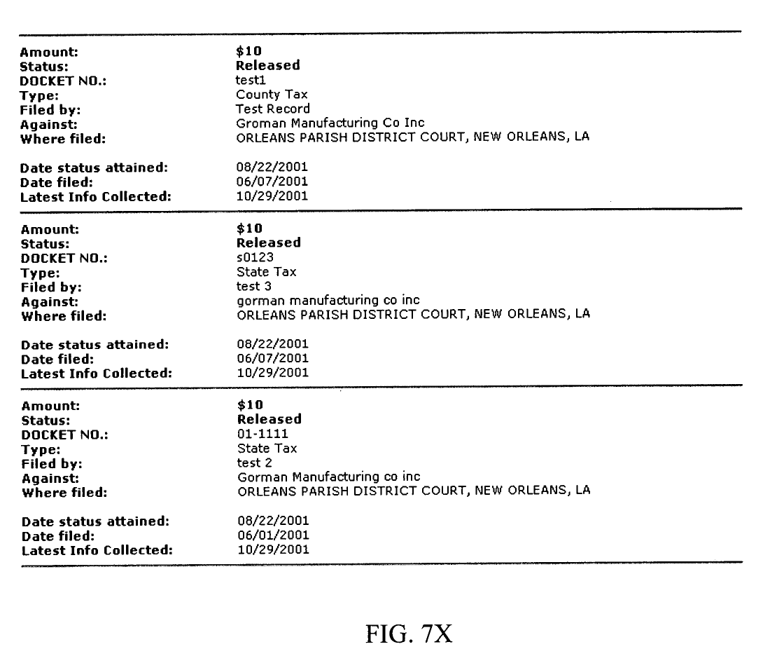

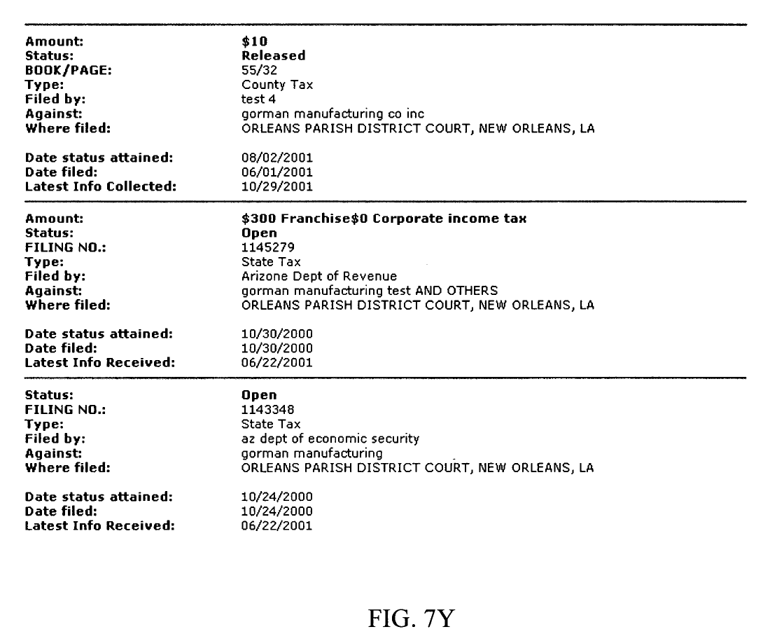

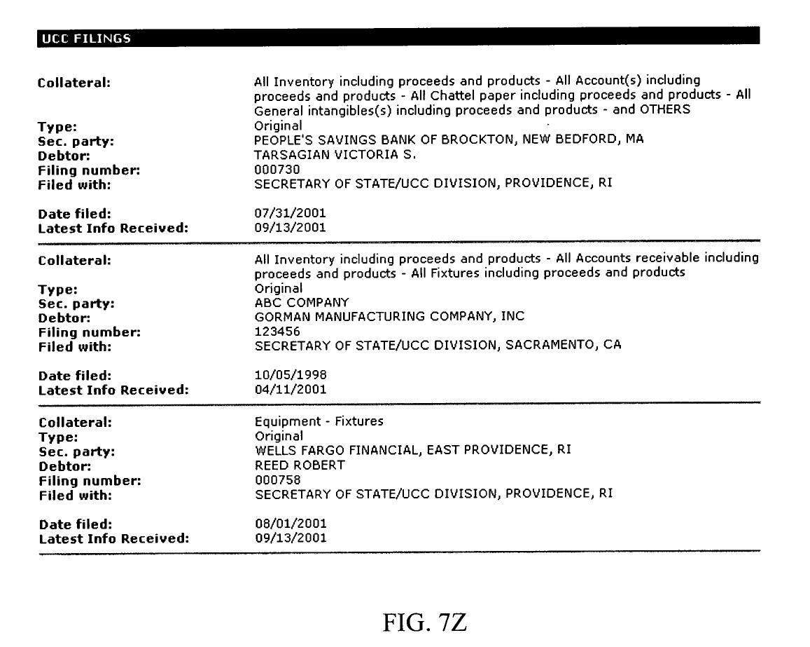

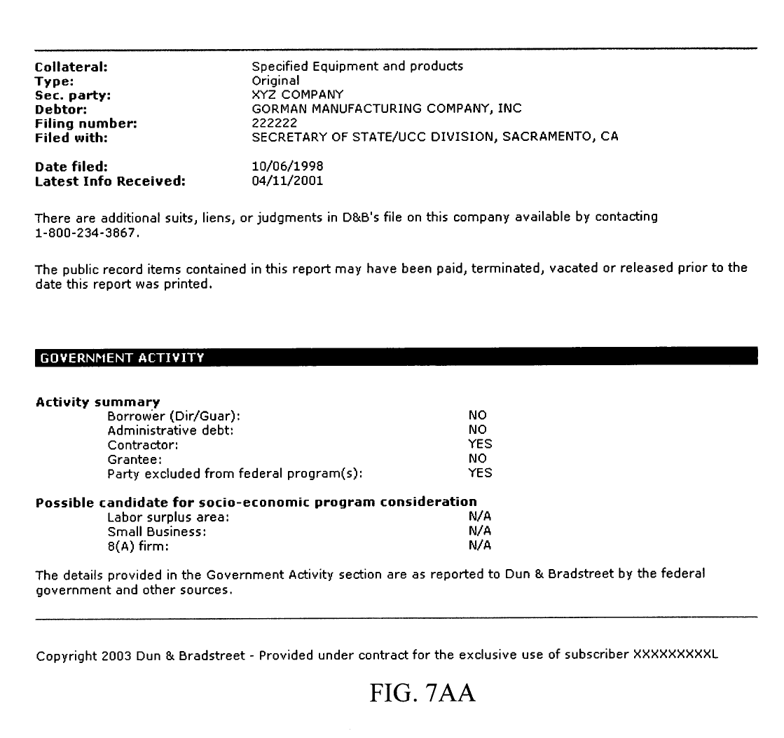

In the example reports (See for example FIGS. 7A-7AA and 8A-8V), there are four sections related to payment performance scores: scores by time period (FIG. 1), yearly trend of scores (FIG. 2), score by industry (FIG. 3), and score by size of credit extended (FIG. 4). Various embodiments have one or more of these sections or equivalent information arranged and presented in various ways, such as in formats suitable for email, printing, faxing, posting on websites, storing, and the like. A payment performance score is calculated as a weighted average of all the known trade experiences within a measuring period, using a minimum of four trade experiences. Trade experiences are stored in at least one storage medium, such as a database.

FIG. 1 shows scores by time period in a table 100. In this example, a payment performance score is based on data with up to 90 trade experiences during a 12 month period where the single largest high credit was $200,000 within that 12 months.

The first column in table 100 in FIG. 1 is a time period of 3, 6, 9, and 12 months. If there was no score calculated for a particular period, it would not be displayed in the table. For example, if there was no 3 month score, the first row displayed would be for the 6 month score. If there were no scores for 12 months, then a message 102 would be displayed indicating a lack of adequate trade experiences to calculate a score.

The second column is the corresponding payment performance score. The 3 month score is calculated for a 3 month manner of payment times 3 month experiences using a current weighted average calculation with a minimum of four experiences. The 6 month score is calculated for a 6 month manner of payment times 6 month experiences using the current weighted average calculation with a minimum of four experiences. The 9 month score is calculated for a 9 month manner of payment times 9 month experiences using the current weighted average calculation with a minimum of four experiences. The 12 month score is calculated for a 12 month manner of payment times 12 month experiences using the current weighted average calculation with a minimum of four experiences.

The third column in table 100 in FIG. 1 is the largest high credit, which is the largest experience seen within the measuring period, i.e., 3, 6, 9, and 12 months. The fourth column in table 100 in FIG. 1 is the most seen payment, which is the manner of payment seen most within the measuring period in absolute terms (not a weighted average). For example, if there are five experiences and three are slow 30 days, the outcome is slow 30 days regardless of the transaction size. The fifth column in table 100 in FIG. 1 is a graphical representation of the new score to be created.

FIG. 2 shows a yearly trend of scores in a chart 200. In this example, a company's score over the past year (May 2002 to April 2003) is shown using values based on payment experiences collected over the last 14 months. The chart 200 contains a rolling 12 month snapshot of a 3 month score. Each point on the chart 200 is calculated in the same manner as the 3 month score from table 100 in FIG. 1. Each point represents a score calculated from data for a particular month plus data for the prior 2 months. Thus, for a yearly trend, 14 months of data is needed. For example, to calculate a May 2002 score, data from March, April, and May 2002 is used. In this example, if no scores are available or less than three scores are available, then a yearly trend is not provided. If three or more scores are available, then scores are plotted on a chart without connecting lines.

FIG. 3 shows score by industry in a table 300. In this example, scores indicate how a particular company pays specific industries. The scores are values based on payment experiences collected over the past 14 months.

The first column in table 300 indicates an industry, such as by an industry name corresponding to the four-digit standard industrial classification (SIC). The second column in table 300 also indicates an industry, such as by the four-digit SIC. All the industries in which at least one score (3, 6, 9 or 12 month) can be calculated are listed. In this example, the industries are ordered from high to low number of total payment experiences. The third column in table 300 provides a number of total payments corresponding to each industry. The number of total payments is the number of experiences that were used to calculate the score from the database for the past 12 months.

The fourth column is a current trend. In this example, the current trend indicates whether the trend is up, down, unchanged or unavailable. The trend is generated using changes greater than ±6. Trends are calculated in comparison to the 12 month score based on availability. If a 3 month score is available, it is compared to the 12 month score. Otherwise, if a 3 month score is not available, a 6 month score is compared to a 12 month score. Otherwise, if a 6 month score is not available, a 9 month score is compared to a 12 month score. Otherwise, if only a 12 month score is available, no score is provided (UN). The fifth, sixth, seventh, and eight columns indicate industry specific scores. These scores are calculated in the same manner as the other scores in table 100 in FIG. 1.

FIG. 4 shows score by size of credit in a table 400. In this example, scores are provided by the dollar amount of credit extended and values are based on payment experiences collected over the past 14 months. The first column of table 400 is the size of credit extended, which is in bands of each experience based on the credit amount extended. The bands are per a current payment trends profile. The second column of table 400 is total payments, which is a number of experiences in a database for the past 12 months. The third column of the table 400 is the current trend. The current trend is generated using changes greater than ÷6 and calculated as a comparison to the 12 month score based on availability. If a 3 month score is available, it is compared to the 12 month score. Otherwise, if a 3 month score is not available, a 6 month score is compared to a 12 month score. Otherwise, if a 6 month score is not available, a 9 month score is compared to a 12 month score. Otherwise, if only a 12 month score is available, no score is provided (UN). The fifth, sixth, seventh, and eight columns of table 400 are scores that are calculated in the same manner as the other scores in table 100 in FIG. 1.

There is an example method of calculating payment performance scores that uses a particular manner of payment and period over which the variables are calculated. A 3 month score is calculated using a 3 month manner of payment for 3 calendar months worth of experiences on each account for a case. A case is data for a company that is associated with a unique corporate identifier. Scores may be calculated on-the-fly or pre-calculated and stored. The following table illustrates how different scores are calculated, in this example.

TABLE 1
How different scores are calculated

| Score | Definition | Manner of Payment | Time Period |
|---|---|---|---|
| 3-month | 3X3 | 3-month | 3 months |
| 6-month | 6X6 | 6-month | 6 months |
| 9-month | 9X9 | 9-month | 9 months |
| 12-month | 12X12 | 12-month | 12 months |

There is an example method of calculating industry specific scores that involves calculation of payment performance scores for each case by taking into consideration only the experiences from a particular industry. All experiences for a case are categorized by industry type (e.g., using a four-digit SIC) and the number of experiences associated with each category is calculated. Any category having less than four eligible experiences is removed. Then, 3, 6, 9, and 12 month scores are calculated for each category. Scores may be calculated on-the-fly or pre-calculated and stored.

An experience is eligible if at least four trade experiences with a manner of payment or a comment (e.g., placed for collection, bad debt, satisfactory, or unsatisfactory) are available. In this example, if a case that has zero trade experiences available, then a score of 998 is assigned to indicate insufficient data. If a case has one, two, or three trade experiences available, a score of 999 is assigned to indicate the score is not available.

There is an example method of calculating credit specific scores that involves calculation of payment performance scores for each case by taking into consideration only the experiences in a specific credit range. An example of credit ranges is: (1) under $1,000, (2) $1,000 to $4,999, (3) $5,000 to $14,999, (5) $15,000 to $49,999, (6) $100,000 and above. All experiences for a case are categorized by credit ranges and the number of experiences associated with each category is calculated. Any category having less than four eligible experiences is removed. Then, 3, 6, 9, and 12 month scores are calculated for each category. Scores may be calculated on-the-fly or pre-calculated and stored.

In this example, if a case is for a headquarters, then all the trade experiences corresponding to all branches associated with the headquarters are considered for score calculation as well as trade experiences associated with the headquarters itself. If the case is for a branch, then only trade experiences corresponding to that branch are considered for score calculation.

Some experiences are not considered for score calculation, such as poster reject, VTAU reject, ANSH deletes, i-cases, unapproved, blocked, and the like.

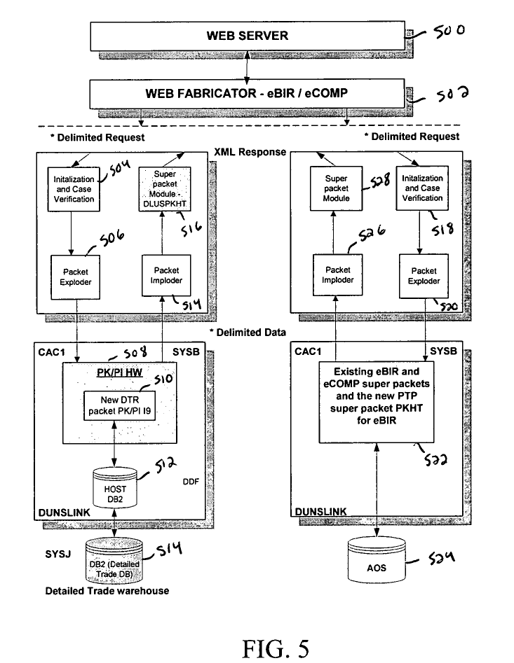

FIG. 5 shows an example system architecture for fabricating reports. A web server 500 communicates with a web fabricator 502. The web fabricator 502 fabricates data for reports, such as a business information report or a comprehensive report. The web fabricator 502 makes various requests for various packets in at least one database system. In this example, after a request is made, there is a first initialization and case verification 504 and a first packet exploder 506 retrieves data. Packet exploders and imploders translate data between various formats. A super packet (PK/PIHW) 508 includes a sub packet PK/PII9 510 that includes methods for retrieving data from a first database 512 and a detailed trade database 514. After the data is retrieved and arranged for the packets, a first packet imploder 516 processes the data and a first super packet module 516 returns data to the web fabricator 502. Other requests from the web fabricator 502 are sent to a second initialization and case verification 518 and a second packet exploder 520 to retrieve data. Another super packet 522 includes methods for retrieving data from a second database 524, advanced office system (AOS). After the data is retrieved and arranged for the packets, a second packet imploder 526 processes the data and a second super packet module 528 returns data to the web fabricator 502. In this example system, some data is in the first database 514, while other data is in the second database 524. However, various architectures with at least one database may be used for fabricating reports. Also, various communication protocols, data layouts, and database systems may be used.

In a preferred embodiment, approximately 23,000 reports per day are processed with a response time of 2-4 seconds at the web fabricator 502 and 4-6 seconds at the website.

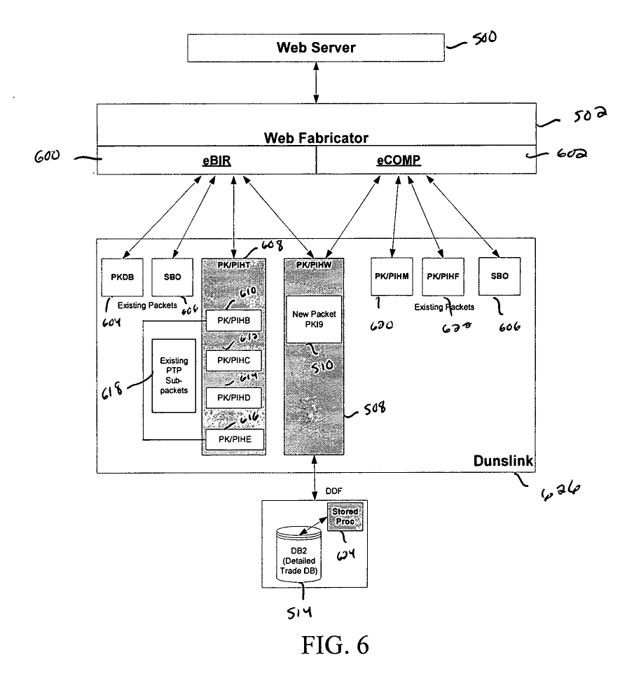

FIG. 6 shows another example system architecture and the various packets for the two example reports, the business information report (eBIR) and the comprehensive report (eCOMP). The web fabricator 502 has a first fabrication component 600 for the eBIR and a second fabrication component 602 for the eCOMP 602. In this example, the first fabrication component 600 retrieves various packets for the report, namely, PK/PIHW 508, PKDB 604, SBO 606, and super packet 608, which includes sub packets PK.PIHB 610, PK/PIHC 612, PK/PIHD 614, and PK/PIHE 616, and payment trend profile (PTP) sub packets 618. The second fabrication component 602 retrieves various packets for the report, namely, PK/PIHW 508, PK/PIHM 620, PK/PIHF 622, and SBO 606. The first database 514 includes a stored procedure 624. The packet processing is performed by a component 626 (e.g., DUNSLink) which communicates with the web fabricator 502 and the detailed trade database 514 as well as the second database 524, advanced office system (AOS) (not shown in FIG. 6, see FIG. 5).

In this example, the packet identifiers, such as PK/PIHW 508, have four letters. The first letter is P (packet) or R (report). The second letter is K (headquarters) or I (branch). The third and fourth letters identify a particular packet. For example, PKI9 identifies a detailed trade data packet.

In this example, the web server 500 presents a user interface and receives information, such as unique corporate identifiers, customer information, and report requests and forwards the information to the web fabricator 502. The web fabricator 502 is a web server that produces reports in various formats, such as using extensible markup language (XML) style sheets (XSL) and transformations (XSLT) to create hypertext markup language (HTML) reports.

In this example, the first fabrication component 600 and the second fabrication component 602 are processors with stored instructions having rules used to determine which packets are needed for the reports. Data layouts in XML and data from at least database 514 are returned to the first fabrication component 600 and the second fabrication component 602 by the component 626.

In this example, the web fabricator 502 takes in one or more XML data streams, and based on a data product (e.g., report) request, applies a set of one or more XSL files in an XSLT translation process with an output of one or more HTML files. The system is capable of fabricating multiple different versions of a data product based on an incoming request. The data products available may be different, depending on the web server 500. The request includes different information by product determining what type of product to fabricate and various fields to use for accessing a back end system or where to store a response. The resulting products are returned in an XML stream or written to a file system with a return XML pointer to where the files were written.

FIGS. 7A, 7B, 7C, 7D, 7E, 7F, 7G, 7H, 71, 7J, 7K, 7L, 7M, 7N, 7O, 7P, 7Q, 7R, 7S, 7T, 7U, 7V, 7W, 7X, 7Y, 7Z, and 7AA together form a example report. In this example, the report is entitled “Business Information Report” (eBIR). Various eBIR reports have various sections and contain various types of data. This example report is formatted for printing, but other reports are formatted differently, such as for emailing.

FIG. 7A shows a report header and business summary section of the eBIR report. The report continues on FIG. 7B with a special events section of the report. FIG. 7C shows a summary analysis section and a customer service section of the report. FIG. 7D shows a history section and a corporate family section of the report. FIG. 7E shows a business registration section and an operations section of the report. FIG. 7F shows a SIC & North American Industry Classification System (NAICS) section and a PAYDEX™ summary section of the report. FIG. 7G shows a PAYDEX™ score section of the report. FIG. 7H shows a PAYDEX™ yearly trend section of the report. FIGS. 71 and 7J show a PAYDEX™ comparison to industry section of the report. FIGS. 7K, 7L, and 7M show a PAYDEX™ plus scores section of the report. FIGS. 7N and 7O show a payment summary section of the report. FIG. 7P shows a payment details section and a finance section of the report. FIG. 7Q shows a key business ratios section of the report. FIG. 7R shows a banking section, a public filings section, and a judgments section of the report. FIGS. 7S, 7T, and 7U show a suits section of the report. FIGS. 7V, 7W, 7X, and 7Y show a liens section of the report. FIG. 7Z shows a uniform commercial code (UCC) filings section of the report. FIG. 7AA shows a government activity section of the report.

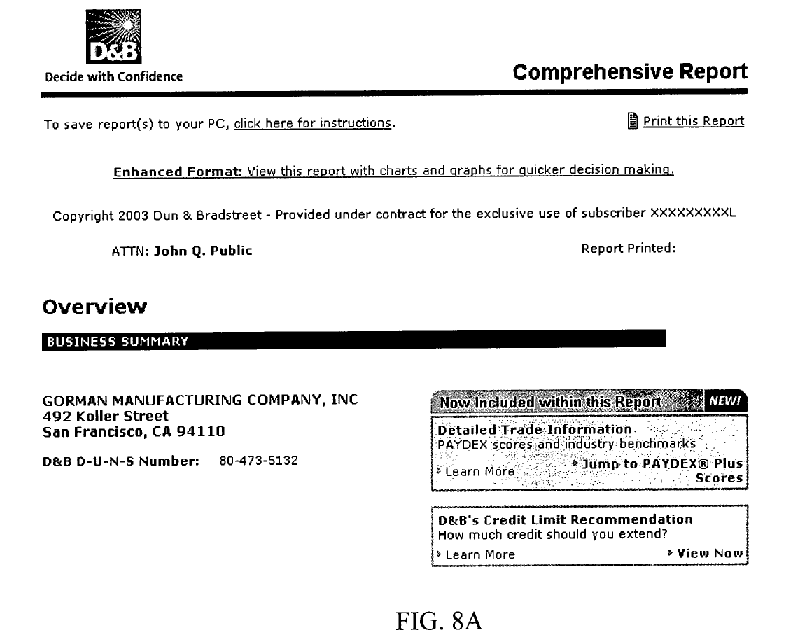

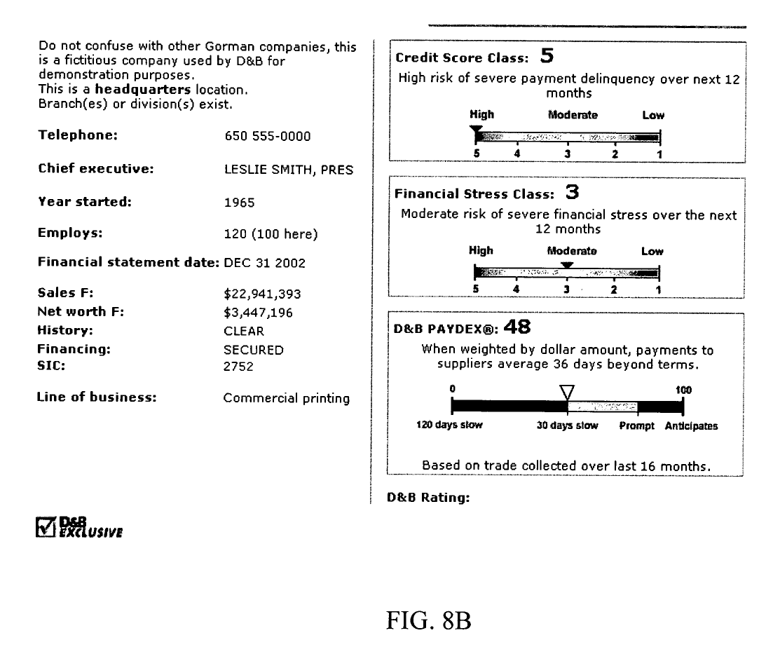

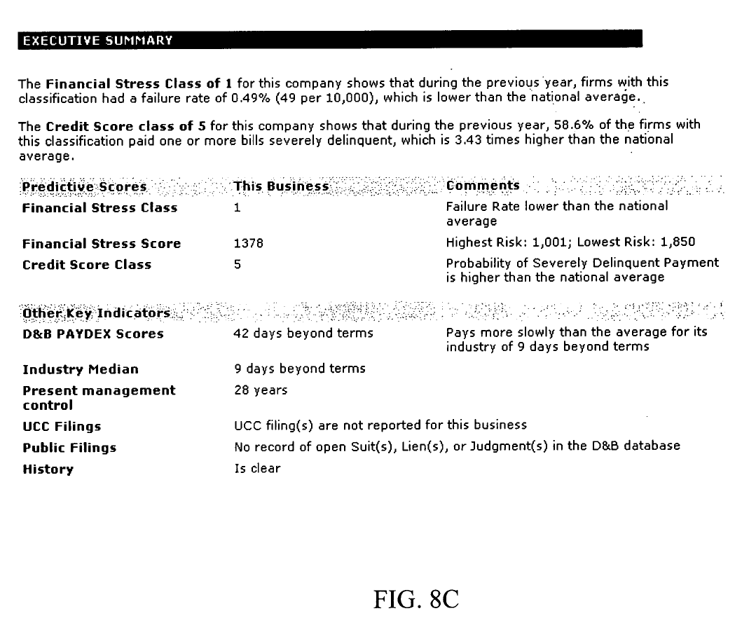

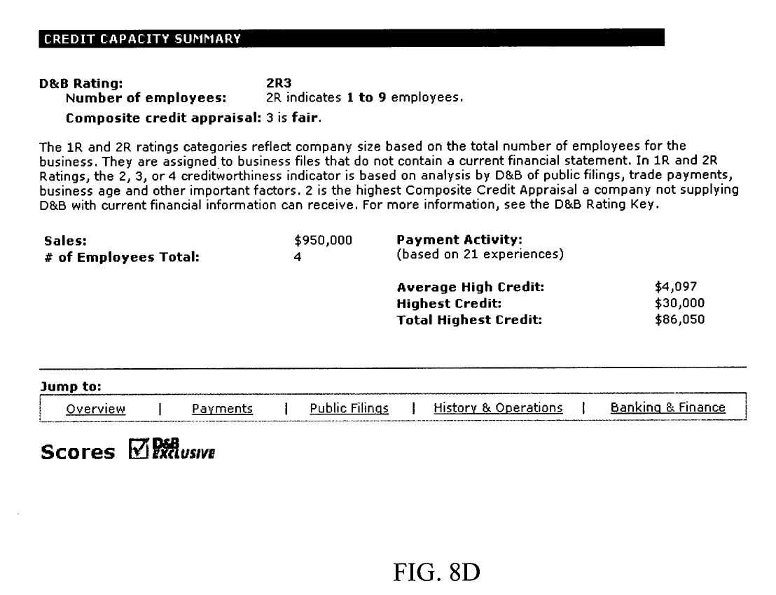

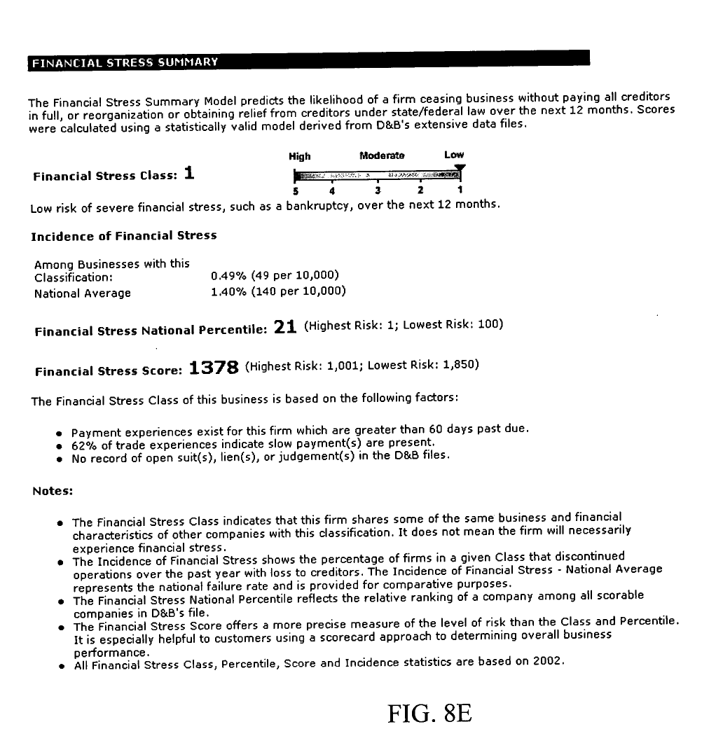

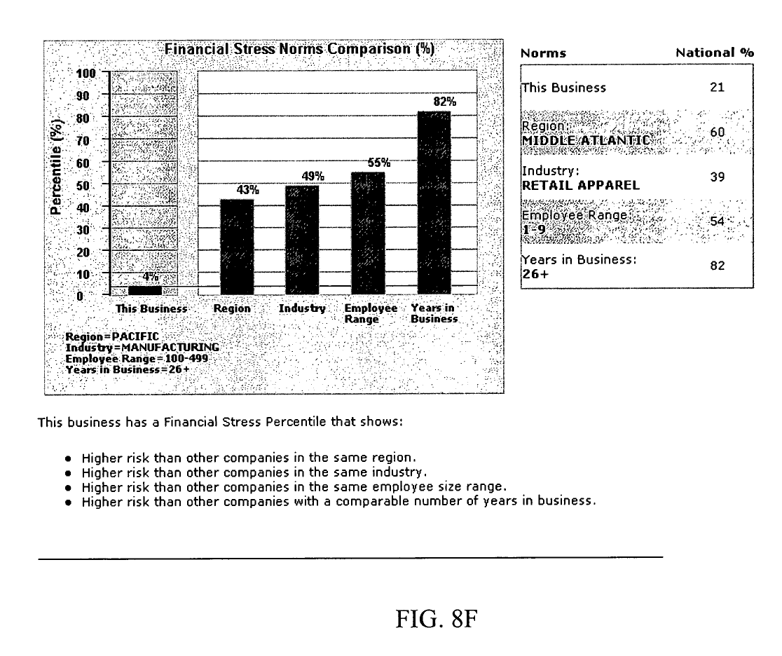

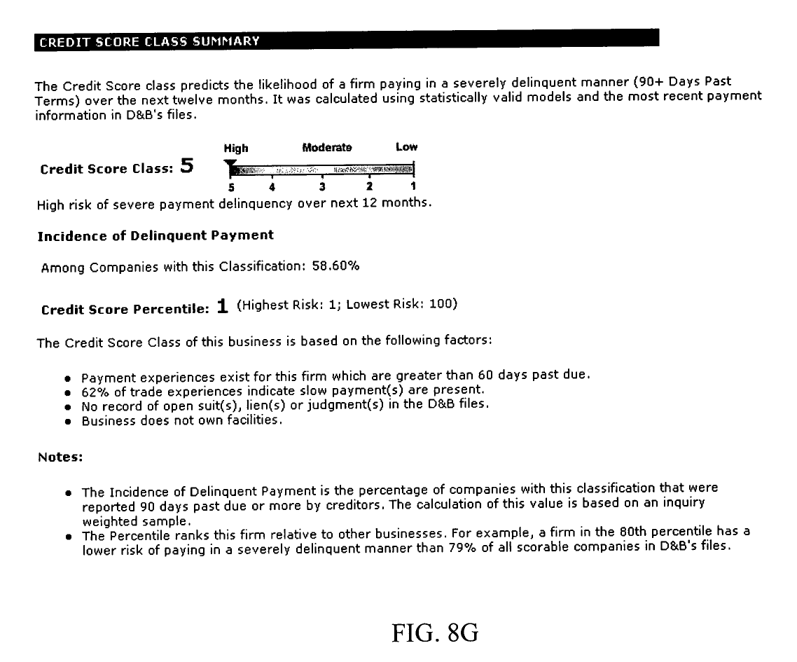

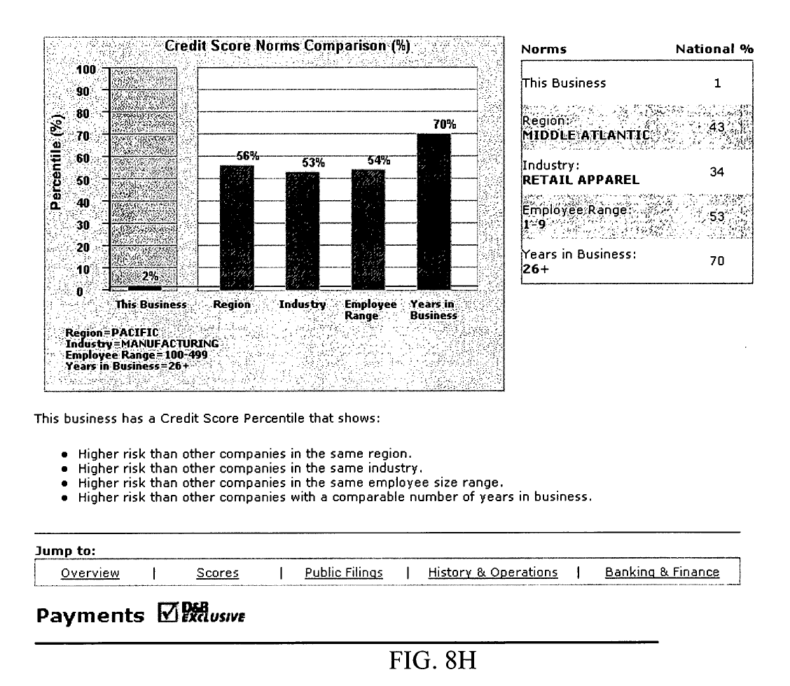

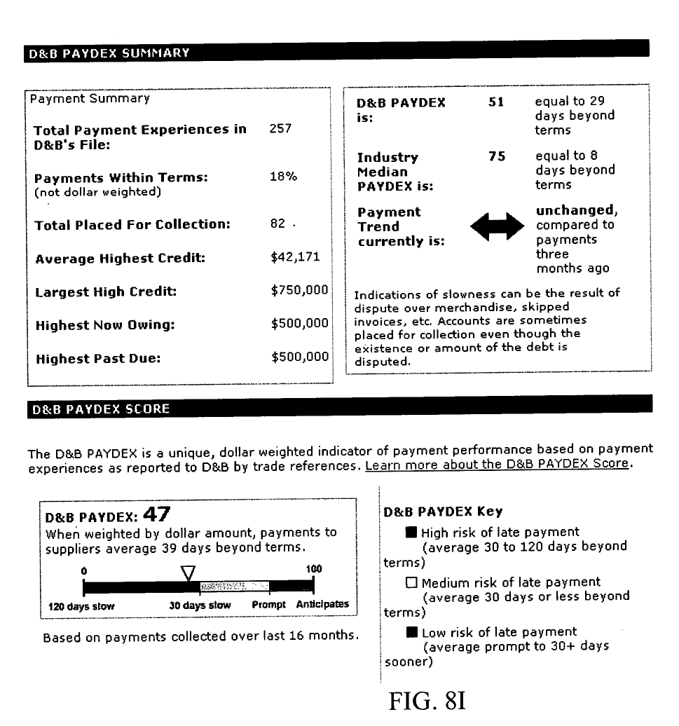

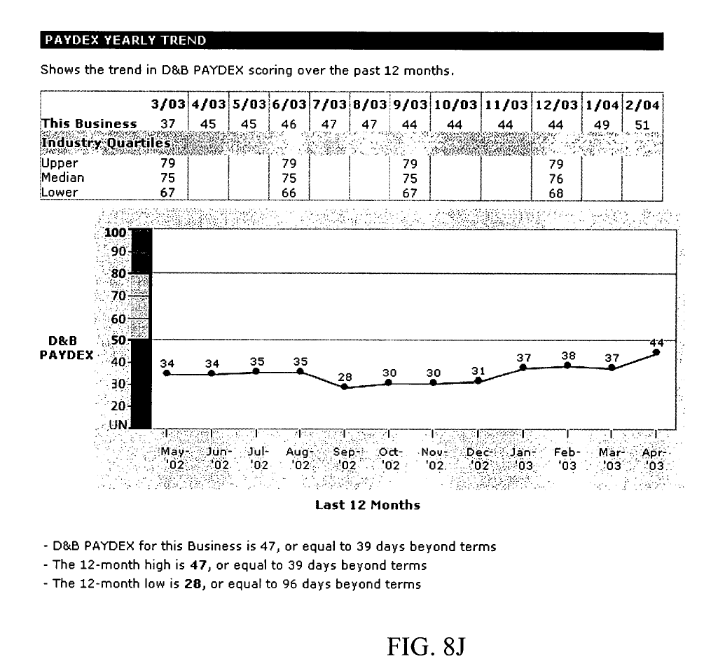

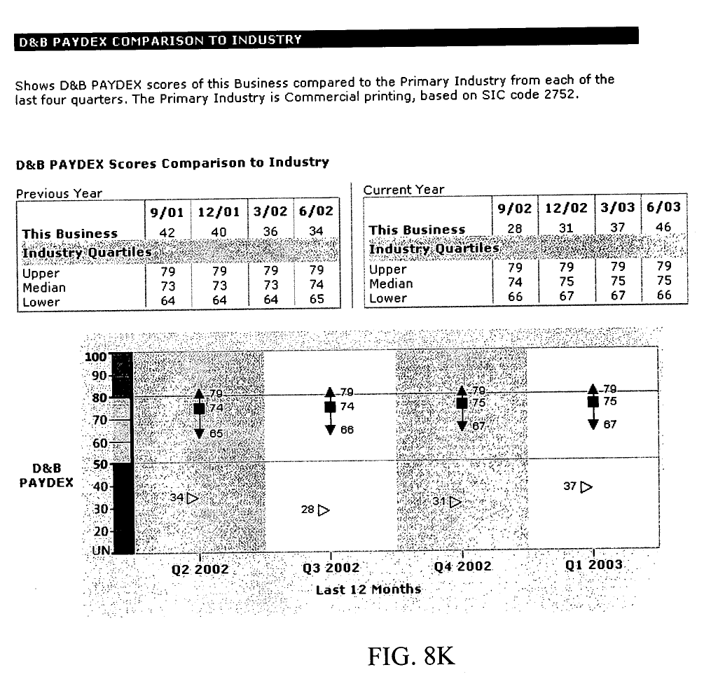

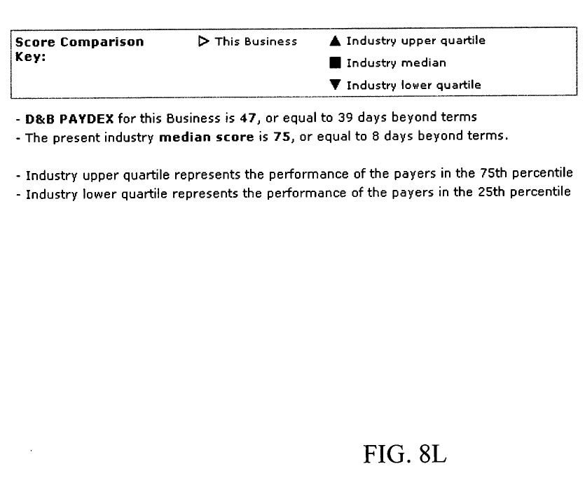

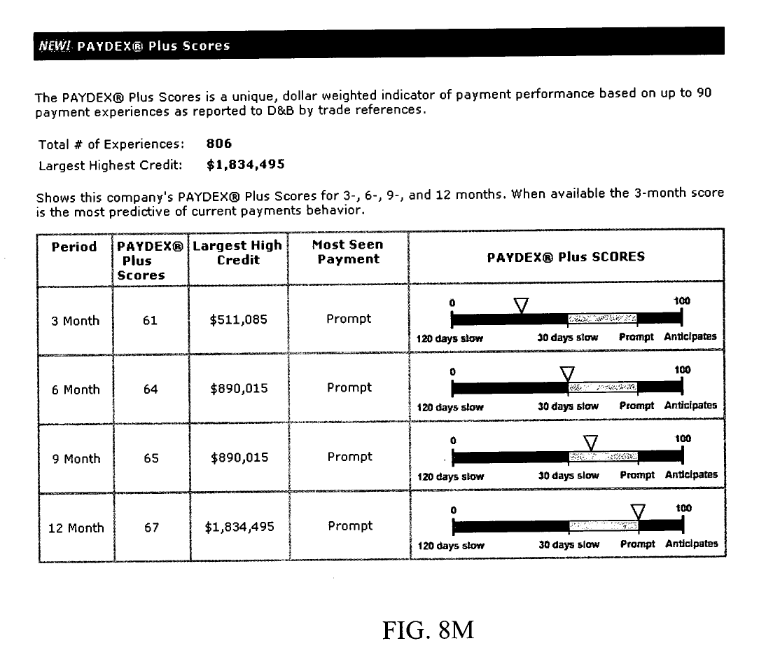

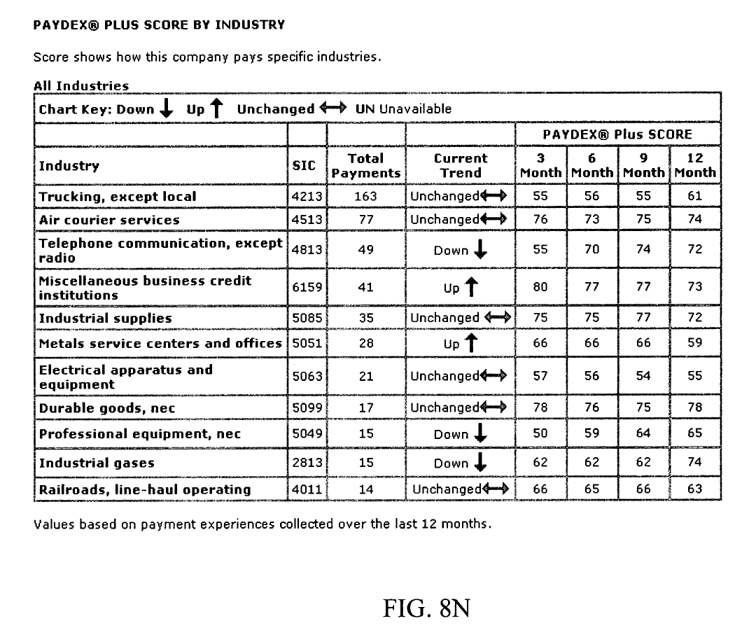

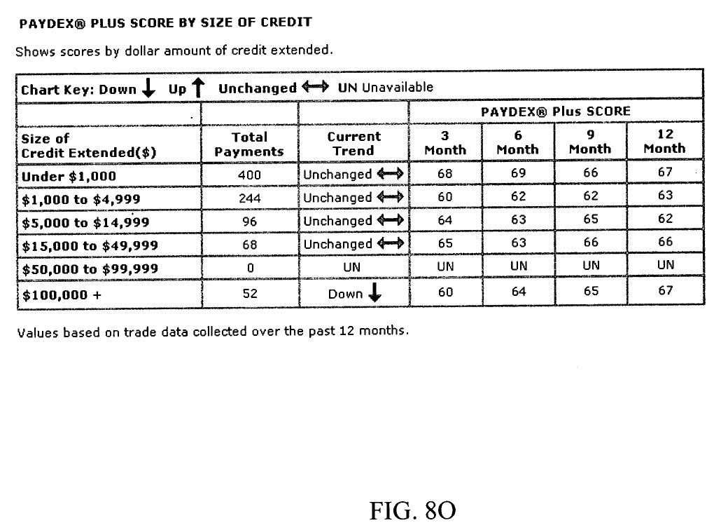

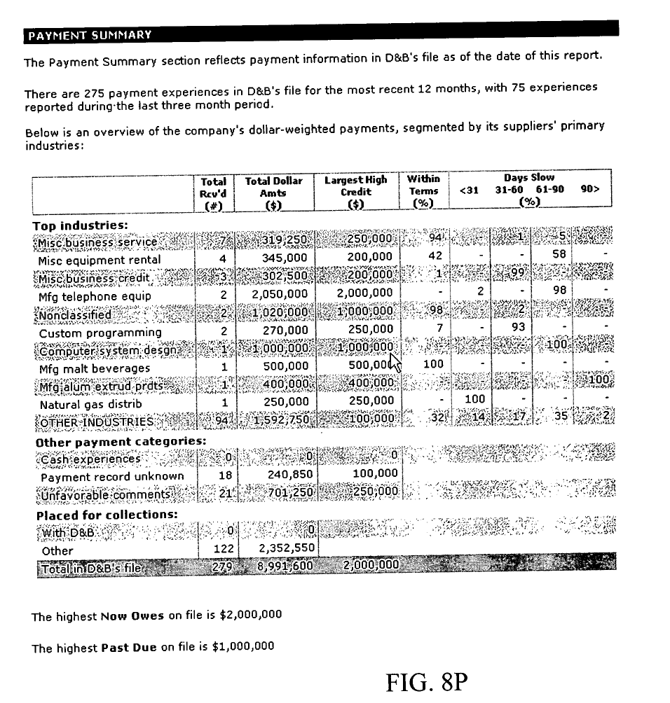

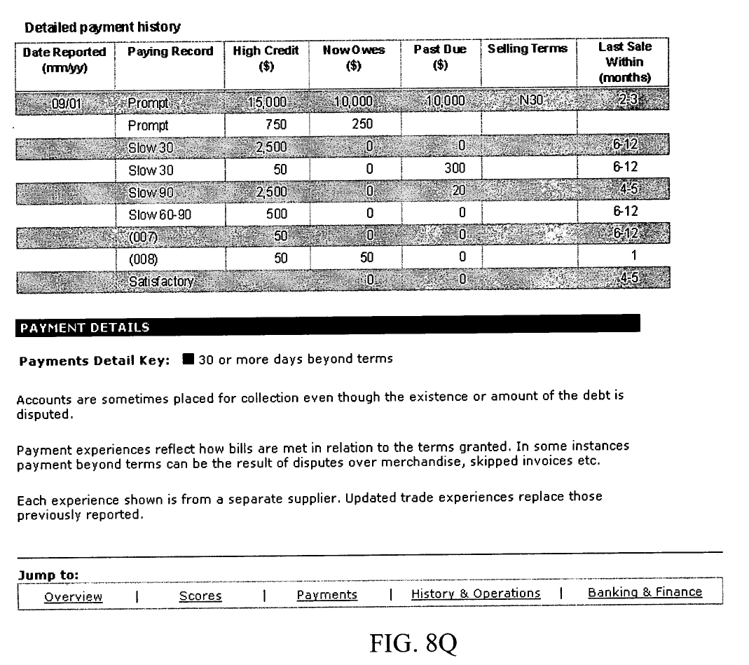

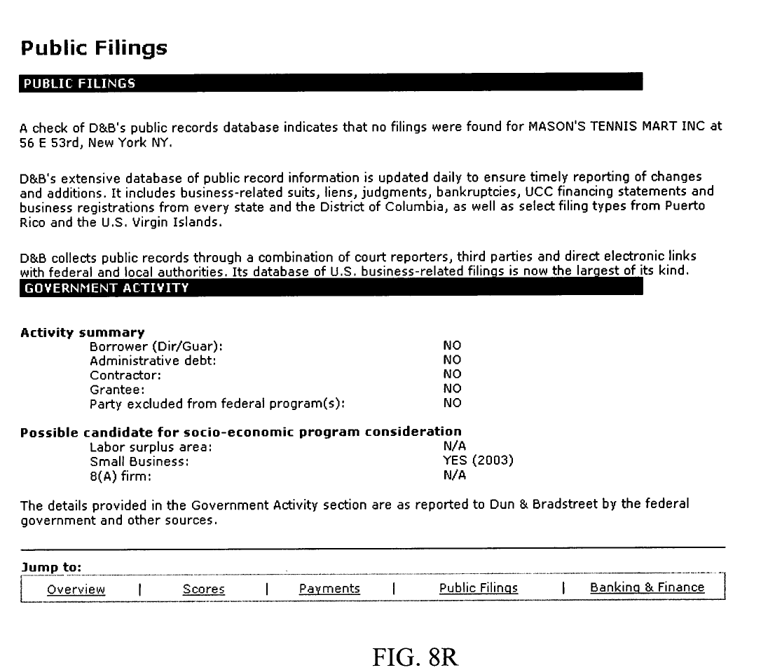

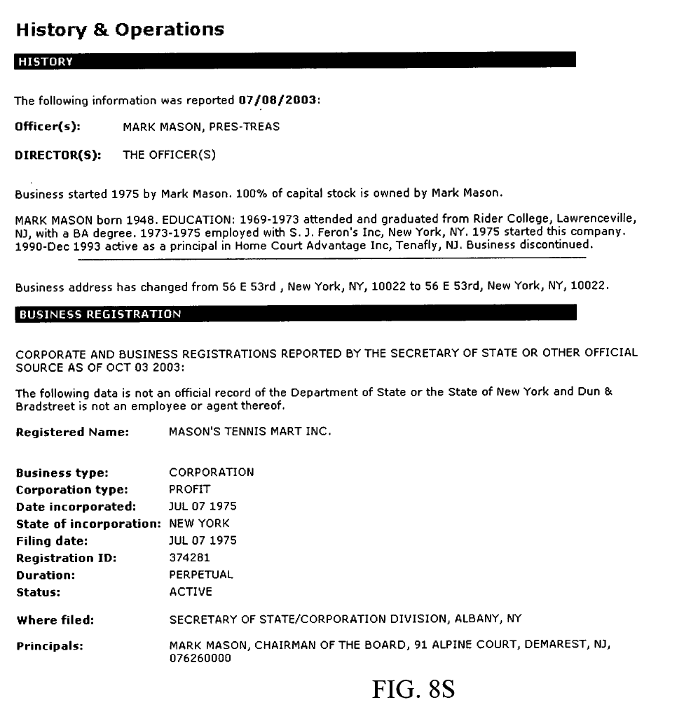

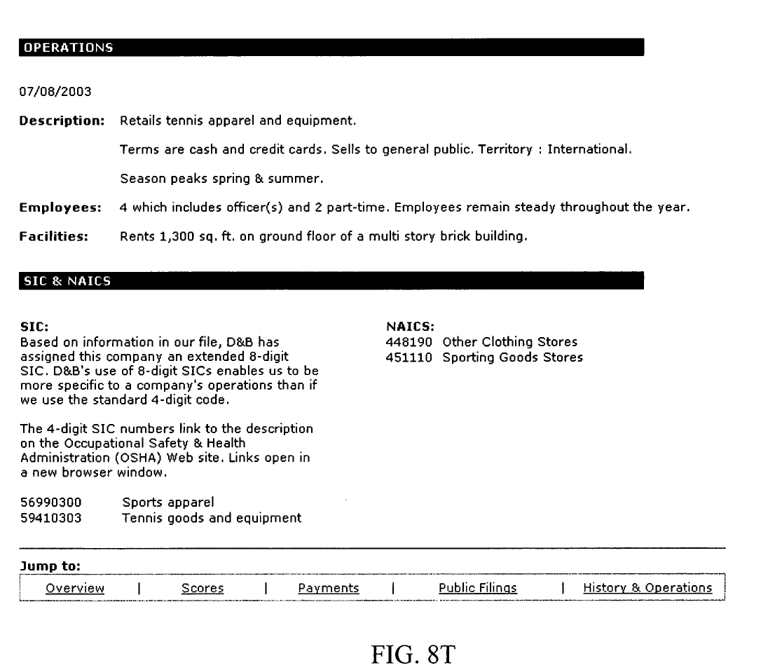

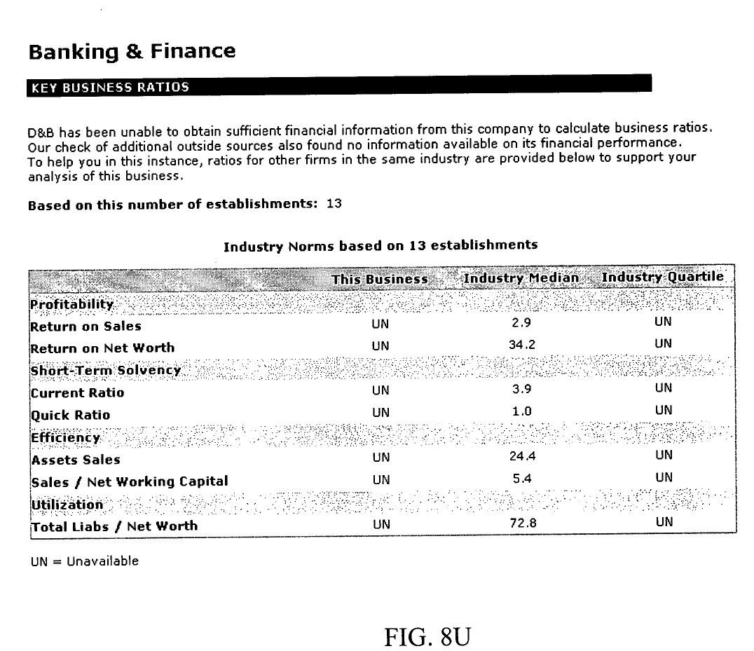

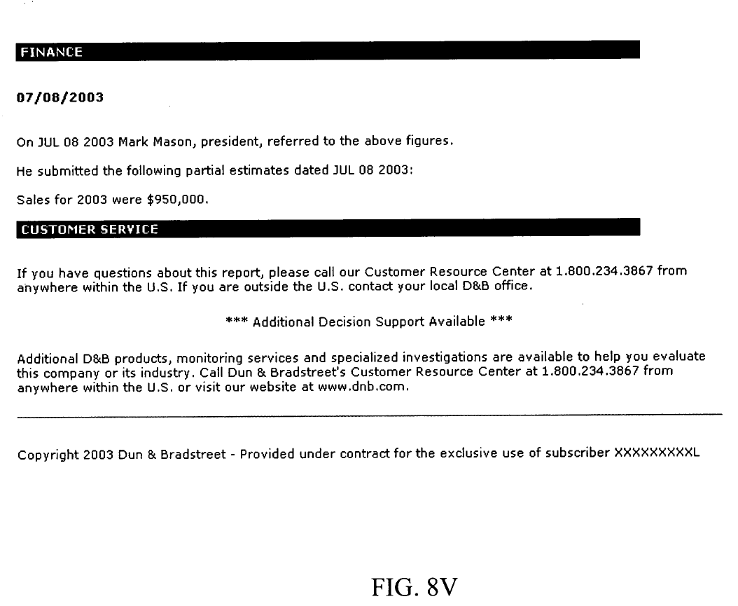

FIGS. 8A, 8B, 8C, 8D, 8E, 8F, 8G, 8H, 81, 8J, 8K, 8L, 8M, 8N, 8O, 8P, 8Q, 8R, 8S, 8T, 8U, and 8V together form another example report. In this example, the report is entitled “Comprehensive Report” (eCOMP). Various eCOMP reports have various sections and contain various types of data. This example report is formatted for printing, but other reports are formatted differently, such as for emailing.

FIGS. 8A and 8B show a report header and a business summary section of the eCOMP report. FIG. 8C shows an executive summary section of the report. FIG. 8D shows a credit capacity summary of the report. FIGS. 8E and 8F show a financial stress summary of the report. FIGS. 8G and 8H show a credit score class summary section of the report. FIG. 81 shows a PAYDEX™ summary section and a PAYDEX™ score section of the report. FIG. 8J shows a PAYDEX™ yearly trend section of the report. FIGS. 8K and 8L show a PAYDEX™ comparison to industry section of the report. FIGS. 8M, 8N, and 8O show a PAYDEX™ plus score section of the report. FIG. 8P shows a payment summary section of the report. FIG. 8Q shows a payment details section of the report. FIG. 8R shows a public filings section and a government activity section of the report. FIG. 8S shows a history section and a business registration section of the report. FIG. 8T shows an operations section and a SIC and NAICS section of the report. FIG. 8U shows a key business ratios section of the report. FIG. 8V shows a finance section and a customer service section of the report.

The example reports have four sections with scores: (1) PAYDEX™ plus scores (FIGS. 7K, 7L, 7M, 8M, 8N, and 8O); (2) 3 month PAYDEX™ plus trend (FIGS. 7H and 8J); (3) PAYDEX™ plus by industry (FIGS. 71, 7J, 8K, and 8L); and (4) PAYDEX™ plus by size of credit extended (FIG. 4). An example enhanced eBIR report (not shown) includes a payment trend report (PTP), which includes a payment trends summary section, a 12 month PAYDEX™ section, and PAYDEX™ comparison to industry quarterly trend section.

As shown in FIGS. 5 and 6, the sub packet PK/PI I9 fabricates the PAYDEX™ sections for these reports. The super packet PKHW has a sub packet PKI9 that has trade data extracted from the detailed trade database 514. PTP packets 618 are used to show details of PTP in a report. A super packet PKHT is used for the eBIR report and has sub packets for extracting data for PTP sections.

In this example, the web fabricator 502, upon receiving a request from a website (e.g., http://www.dnb.com) for a report, triggers a request for corresponding super packets. A credit fabricator (not shown) receives a request for a report from the web fabricator 502 through component 626. The credit fabricator has an initialization program 504, 518 that initializes communication areas, addresses, and passes control to a case verification program 504, 518. The case verification program 504, 518 performs a case lookup and instantiates a product availability check. An exploder program 506, 520 links to the control modules, including data access and formatting programs of each packet. A control module links to corresponding data access modules to retrieve data. Data received from data access modules is formatted with an “*” delimiter in the control programs. The control then returns to the exploder program 506, 520.

Within each of the control modules, there is a data formatter module that in turn invokes one or more data extract modules. The data that is extracted by the extract modules is formatted to a single asterisk delimited string by the formatter module. The exploder program 506, 520 then passes control to the imploder program 514, 526. The imploder program 514, 526 concatenates data from different control modules into one packet and passes control to a super packet program 516, 528. The super packet program 516, 528 reformats the data with XML delimiters and passes the data back to the web fabricator 502. The super packet is similar to other packets, except for the delimiter. Other packets have data delimited by an asterisk, whereas the super packet has data delimited by XML tags. Each data element in the super packet has its own XML start and end tags.

There is an example method of fabricating data. When a report is requested, the web fabricator 502 triggers a request to the component 626 to trigger either the first fabrication component 600 for the eBIR or the second fabrication component 602 for the eCOMP 602. The request undergoes case lookup, product availability check and in-date check, and packet explosion. The packet exploder 506, 520 triggers control modules associated with the request in parallel. For example, if the eBIR report is requested, there are three requests triggered that in turn trigger an associated super packet. Within each super packet, the fabrication process for each of its associated sub packets is triggered in parallel. For example, triggering the PKDB super packet for eBIR triggers PKDW, PKDX, PKDM through PKAT in parallel. Each of these sub packet modules has an associated main or formatting module and one or more data access modules. The data obtained from the access modules is derived and formatted to an asterisk delimited format by the formatting modules. The imploder converts the asterisk delimited string obtained from the individual data sub packets into a single data string. Imploder then passes the data string to the super packet program. The super packet program converts the asterisk delimited text to an XML string. The output of the super packet has its data elements encapsulated within XML tags.

It is to be understood that the drawings and detailed description are intended to be illustrative and not restrictive. Embodiments other than the examples in the drawings and detailed description may be used. Other embodiments will be apparent to those of skill in the art upon reviewing the above description, such as scores over any combination of time periods, reports that can be email, printed, faxed and the like. Structural, logical, and electrical changes may be made without departing from the spirit and scope of the present disclosure. Various designs using hardware, software, and firmware are contemplated by the present disclosure, even though some minor elements would need to change to better support the environments common to such systems and methods, such as various database management systems and programming languages. The present disclosure has applicability to fields other than business information. Therefore, the scope of the present disclosure should be determined with reference to the appended claims, along with the full scope of equivalents to which such claims are entitled.

1. A method for providing detailed trade data, comprising:
receiving a request for a report;
calculating a plurality of scores within a plurality of measuring periods by taking a weighted average of at least 4 trade experiences for each score within each measuring period; and
providing said report, including said scores.

2. The method according to claim 1, wherein said measuring periods are selected from the group consisting of 3, 6, 9, and 12 months.

3. The method according to claim 2, wherein a 3 month score is calculated for a 3 month manner of payment by 3 month trade experiences using a current weighted average calculation with at least 4 trade experiences.

4. The method according to claim 2, wherein a 6 month score is calculated for a 6 month manner of payment by 6 month trade experiences using a current weighted average calculation with at least 4 trade experiences.

5. The method according to claim 2, wherein a 9 month score is calculated for a 9 month manner of payment by 9 month trade experiences using a current weighted average calculation with at least 4 trade experiences.

6. The method according to claim 2, wherein a 12 month score is calculated for a 12 month manner of payment by 12 month trade experiences using a current weighted average calculation with at least 4 trade experiences.

7. The method according to claim 2, further comprising:
providing a largest high credit, said largest high credit being a largest trade experience within said measuring period.

8. The method according to claim 2, further comprising:
providing a most seen payment, said most seen payment being a manner of payment occurring most often within said measuring period.

9. A computer-readable medium having executable instructions stored thereon to perform a method for providing detailed trade data, said method comprising:
receiving a request for a report;
calculating 12 monthly scores by calculating each monthly score as a 3 month score, said 3 month score being calculated for a 3 month manner of payment by 3 month trade experiences using a current weighted average calculation with at least 4 trade experiences; and
providing said report, including said 12 monthly scores.

10. The computer-readable medium according to claim 9, wherein said 3 month score uses a current month and two prior months.

11. The computer-readable medium according to claim 9, wherein a yearly trend is indicated.

12. A computer-readable medium having executable instructions stored thereon to perform a method for providing detailed trade data, said method comprising:
receiving a request for a report;
calculating at least one score for at least one industry by taking a weighted average of at least 4 trade experiences for each score within a measuring period; and
providing said report, including said score.

13. The computer-readable medium according to claim 12, wherein said industry is identified by a standard industrial classification (SIC).

14. The computer-readable medium according to claim 12, wherein said measuring period is selected from the group consisting of 3, 6, 9, and 12 months.

15. The computer-readable medium according to claim 12, further comprising providing a number of total payments for each industry, said number of total payments being a number of experiences used to calculate said score.

16. The computer-readable medium according to claim 12, further comprising providing a current trend.

17. The computer-readable medium according to claim 16, wherein said current trend is calculated in comparison to a 12 month score with a measuring period of 12 months.

18. The computer-readable medium according to claim 17, wherein a 3 month score is compared to said 12 month score.

19. The computer-readable medium according to claim 17, wherein a 6 month score is compared to said 12 month score.

20. The computer-readable medium according to claim 17, wherein a 9 month score is compared to said 12 month score.

21. A computer-readable medium having executable instructions stored thereon to perform a method for providing detailed trade data, said method comprising:
receiving a request for a report;
calculating a plurality of scores for a plurality of credit ranges by taking a weighted average of at least 4 trade experiences for each score within a measuring period, said credit ranges being based on a credit amount extended and a current payment trend profile; and
providing said report, including said scores.

22. The computer-readable medium according to claim 21, further comprising:
providing a total payments for each credit range, said total payments being a number of trade experiences for a past 12 months.

23. The computer-readable medium according to claim 21, wherein said scores are for an industry.

24. The computer-readable medium according to claim 21, further comprising:
providing a current trend, said current trend is calculated in comparison to a 12 month score with a measuring period of 12 months.

25. The computer-readable medium according to claim 21, wherein a 3 month score is compared to said 12 month score.

26. The computer-readable medium according to claim 21, wherein a 6 month score is compared to said 12 month score.

27. The computer-readable medium according to claim 21, wherein a 9 month score is compared to said 12 month score.

28. A system for providing detailed trade data, comprising:
a web fabricator for fabricating a report, said report having at least one score, said score being calculated within a measuring period by taking a weighted average of at least 4 trade experiences within said measuring period;
at least one database system for storing data for said report and said trade experiences; and
a component to retrieve data associated with said report from said database system, calculate said score, and forward said score and said data to said web fabricator.

29. The system according to claim 28, wherein said report includes a yearly trend.

30. The system according to claim 28, wherein said report includes scores segmented by industry.

31. The system according to claim 28, wherein said report includes scores segmented by size of credit extended.

32. The computer-readable medium according to claim 28, wherein said measuring period is selected from the group consisting of 3, 6, 9, and 12 months.
